(19) United States
(12) Patent Application Publication
(10) Pub. No.: US 2025/0377521 A1
(43) Pub. Date: Dec. 11, 2025

(54) OPTICAL IMAGING SYSTEM

(71) Applicant: SAMSUNG ELECTRO-MECHANICS CO., LTD., Suwon-si (KR)

(72) Inventors: You Jin JEONG, Suwon-si (KR); Jae Hyuk HUH, Suwon-si (KR); So Mi YANG, Suwon-si (KR); Soo Bin HA, Suwon-si (KR)

(73) Assignee: SAMSUNG ELECTRO-MECHANICS CO., LTD., Suwon-si (KR)

(21) Appl. No.: 19/174,357

(22) Filed: Apr. 9, 2025

(30) Foreign Application Priority Data
Jun. 11, 2024 (KR) 10-2024-0075827
Sep. 30, 2024 (KR) 10-2024-0133151

(51) Int. Cl. G02B 13/00; G02B 9/64

(52) U.S. Cl. CPC G02B 13/0045; G02B 9/64; G02B 13/0055

(57) ABSTRACT

An optical imaging system includes a plurality of lenses sequentially disposed from an object side. The plurality of lenses include a first lens, a second lens, a third lens, a fourth lens, a fifth lens, a sixth lens, and a seventh lens disposed in this order. The second lens has positive refractive power. 0.9<|(R1+R2)/(R1−R2)|<1.1, and 0.4<TTL/(2×IMG HT)<0.65 are satisfied, where R1 is a radius of curvature of an object-side surface of the first lens, R2 is a radius of curvature of an image-side surface of the first lens, TTL is a distance on an optical axis from the object-side surface of the first lens to an imaging plane, and IMG HT is a half of a diagonal length of the imaging plane.

### CROSS-REFERENCE TO RELATED APPLICATIONS

This application claims the benefit under 35 USC 119(a) of Korean Patent Application Nos. 10-2024-0075827 filed on Jun. 11, 2024, and 10-2024-0133151 filed on Sep. 30, 2024, in the Korean Intellectual Property Office, the entire disclosures of which are incorporated herein by reference for all purposes.

### BACKGROUND

### 1. Field

The present disclosure relates to an optical imaging system.

### 2. Description of the Background

A recent portable terminal may include a camera including an optical imaging system including a plurality of lenses to enable video calls and image capturing.

In addition, as functionality of cameras in portable terminals gradually increases, the demand for cameras for portable terminals having high resolution has been increasing.

In addition, as portable terminals gradually decrease in size, a reduction in thickness has been required for cameras for portable terminals. Thus, an objective may be to develop an optical imaging system having high resolution while having a reduced thickness.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a plurality of lenses sequentially disposed from an object side. The plurality of lenses include a first lens, a second lens, a third lens, a fourth lens, a fifth lens, a sixth lens, and a seventh lens disposed in this order. The second lens has positive refractive power. 0.9<|(R1+R2)/(R1−R2)|<1.1, and 0.4<TTL/(2×IMG HT)<0.65 are satisfied, where R1 is a radius of curvature of an object-side surface of the first lens, R2 is a radius of curvature of an image-side surface of the first lens, TTL is a distance on an optical axis from the object-side surface of the first lens to an imaging plane, and IMG HT is a half of a diagonal length of the imaging plane.

|R1|>500 mm may be satisfied.

The object-side surface of the first lens may be a plane in a paraxial region thereof.

The object-side surface of the first lens may be a spherical surface.

−35<v1−v2≤0 may be satisfied, where v1 is an Abbe number of the first lens, and v2 is an Abbe number of the second lens.

n2+n3>3.15 may be satisfied, where n2 is a refractive index of the second lens, and n3 is an Abbe number of the third lens.

1.0<TTL/f<1.7 may be satisfied, where f is a total focal length of the plurality of lenses.

−2.5<f−TTL_2<−0.2 may be satisfied, where f is a total focal length of the plurality of lenses, and TTL_2 is a distance on the optical axis from an object-side surface of the second lens to the imaging plane.

0.05<|f/f1|<1.3 may be satisfied, where f is a total focal length of the plurality of lenses, and f1 is a focal length of the first lens.

0.001<D1/f<0.04 may be satisfied, where D1 is a distance on the optical axis between the image-side surface of the first lens and an object-side surface of the second lens, and f is a total focal length of the plurality of lenses.

0.4<f/f2+f/f3<1.7 may be satisfied, where f is a total focal length of the plurality of lenses, f2 is a focal length of the second lens, and f3 is a focal length of the third lens.

A focal length of the second lens may have a smallest absolute value, among absolute values of focal lengths of the plurality of lenses.

The seventh lens may be a lens disposed to be closest to the imaging plane, and the third lens may have negative refractive power, the fourth lens may have positive refractive power, and the fifth lens may have negative refractive power.

The optical imaging system may further include an eighth lens disposed between the seventh lens and the imaging plane, wherein each of the fourth lens and the sixth lens may have positive refractive power, and the eighth lens may have negative refractive power.

The optical imaging system may further include an eighth lens and a ninth lens disposed between the seventh lens and the imaging plane, wherein the fourth lens may have positive refractive power.

When the number of lenses, among the plurality of lens, having a focal length greater than a total focal length of the plurality of lenses is Nfa and the number of the plurality of lenses is NL, Nfa>NL/2 may be satisfied.

Other features and aspects will be apparent from the following detailed description, the drawings, and the claims.

### BRIEF DESCRIPTION OF DRAWINGS

FIG. 1 is a block diagram illustrating an optical imaging system according to a first example embodiment of the present disclosure.

FIG. 2 is a diagram illustrating aberration properties of the optical imaging system illustrated in FIG. 1.

FIG. 3 is a block diagram illustrating an optical imaging system according to a second example embodiment of the present disclosure.

FIG. 4 is a diagram illustrating aberration properties of the optical imaging system illustrated in FIG. 3.

FIG. 5 is a block diagram illustrating an optical imaging system according to a third example embodiment of the present disclosure.

FIG. 6 is a diagram illustrating aberration properties of the optical imaging system illustrated in FIG. 5.

FIG. 7 is a block diagram illustrating an optical imaging system according to a fourth example embodiment of the present disclosure.

FIG. 8 is a diagram illustrating aberration properties of the optical imaging system illustrated in FIG. 7.

FIG. 9 is a block diagram illustrating an optical imaging system according to a fifth example embodiment of the present disclosure.

FIG. 10 is a diagram illustrating aberration properties of the optical imaging system illustrated in FIG. 9.

FIG. 11 is a block diagram illustrating an optical imaging system according to a sixth example embodiment of the present disclosure.

FIG. 12 is a diagram illustrating aberration properties of the optical imaging system illustrated in FIG. 11.

FIG. 13 is a block diagram illustrating an optical imaging system according to a seventh example embodiment of the present disclosure.

FIG. 14 is a diagram illustrating aberration properties of the optical imaging system illustrated in FIG. 13.

FIG. 15 is a block diagram illustrating an optical imaging system according to an eighth example embodiment of the present disclosure.

FIG. 16 is a diagram illustrating aberration properties of the optical imaging system illustrated in FIG. 15.

FIG. 17 is a block diagram illustrating an optical imaging system according to a ninth example embodiment of the present disclosure.

FIG. 18 is a diagram illustrating aberration properties of the optical imaging system illustrated in FIG. 17.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience. In particular, a shape of a spherical or aspherical surface illustrated in the drawings is only presented as an example, but the present disclosure is not limited thereto.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure may provide an optical imaging system having high resolution while having a reduced thickness.

An optical imaging system according to an example embodiment of the present disclosure may include a plurality of lenses. The plurality of lenses may include at least seven lenses. For example, the optical imaging system according to an example embodiment of the present disclosure may include seven, eight, nine, or ten lenses.

In an example embodiment, a forwardmost lens may refer to a first lens disposed to be closest to an object side, and a rearmost lens may refer to a seventh lens disposed to be closest to an imaging plane (or image sensor).

In an example embodiment, the rearmost lens may refer to an eighth lens disposed to be closest to the imaging plane (or image sensor).

In an example embodiment, the rearmost lens may refer to a ninth lens disposed to be closest to the imaging plane (or image sensor).

In an example embodiment, the rearmost lens may refer to a tenth lens disposed to be closest to the imaging plane (or image sensor).

In addition, as used herein, all numerical values for a radius of curvature, a thickness, a distance, a focal length, and the like of a lens may be indicated in millimeters (mm), and a field of view (FOV) may be indicated in degrees (°).

In addition, in the description of a shape of each lens, one surface having a convex shape may mean that a paraxial portion of the surface is convex, and one surface having a concave shape may mean that a paraxial portion of the surface is concave.

Accordingly, even when it is described that one surface of a lens has a convex shape, an edge portion of the lens may be concave. Similarly, even when it is described that one surface of a lens has a concave shape, an edge portion of the lens may be convex.

In addition, in the description of a shape of each lens, one surface that is a plane may mean that a paraxial region portion of the surface is a plane.

The paraxial region may refer to a highly narrow region in the vicinity of and including an optical axis.

The imaging plane may refer to a virtual surface on which a focal point is formed by the optical imaging system. Alternatively, the imaging plane may refer to one surface of an image sensor receiving light.

The optical imaging system according to an example embodiment of the present disclosure may include at least seven lenses.

In an example embodiment, the optical imaging system may include a first lens, a second lens, a third lens, a fourth lens, a fifth lens, a sixth lens, and a seventh lens, sequentially disposed from the object side. The first to seventh lenses may be spaced apart from each other by predetermined distances along an optical axis.

In an example embodiment, the optical imaging system may include a first lens, a second lens, a third lens, a fourth lens, a fifth lens, a sixth lens, a seventh lens, and an eighth lens sequentially disposed from the object side. The first to eighth lenses may be spaced apart from each other by predetermined distances along an optical axis.

In an example embodiment, the optical imaging system may include a first lens, a second lens, a third lens, a fourth lens, a fifth lens, a sixth lens, a seventh lens, an eighth lens, and a ninth lens, sequentially disposed from the object side. The first to ninth lenses may be spaced apart from each other by predetermined distances along an optical axis.

In an example embodiment, the optical imaging system may include a first lens, a second lens, a third lens, a fourth lens, a fifth lens, a sixth lens, a seventh lens, an eighth lens, a ninth lens, and a tenth lens, sequentially disposed from the object side. The first to tenth lenses may be spaced apart from each other by predetermined distances along an optical axis.

The optical imaging system according to an example embodiment of the present disclosure may further include an image sensor for converting an image of an incident subject into an electrical signal.

In addition, the optical imaging system may further include an infrared filter (hereinafter, referred to as a “filter”) for blocking infrared rays. The filter may be disposed between a rearmost lens and an image sensor.

In addition, the optical imaging system may further include an aperture for adjusting an amount of light.

A plurality of lenses, included in the optical imaging system according to an example embodiment of the present disclosure, may be formed of a plastic material.

In addition, at least one of the plurality of lenses may have an aspherical surface.

In an example embodiment, an object-side surface of a first lens may be a spherical surface, and an image-side surface of the first lens and object-side surfaces and image-side surfaces of the remaining lenses may be aspherical surfaces, respectively.

In an example embodiment, the object-side surface and the image-side surface of the first lens may be spherical surfaces, and the object-side surfaces and the image-side surfaces of the remaining lenses may be aspherical surfaces, respectively.

An aspherical surface of each lens may be represented by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad [ Equation 1 ]$$

In Equation 1, c may represent a curvature of a lens (a reciprocal of a radius of curvature), K may represent a conic constant, and Y may represent a distance from an arbitrary point on an aspherical surface of the lens to an optical axis. In addition, constants A to H, J, and L to P may represent aspherical coefficients. Z(SAG) may represent a distance in an optical axis direction between the arbitrary point on the aspherical surface of the lens and an apex of the aspherical surface.

The optical imaging system according to an example embodiment of the present disclosure may satisfy at least one of conditional equations below.

In an example embodiment, the optical imaging system may satisfy a condition of 0.4<TTL/(2×IMG HT)<0.65. Here, TTL may be a distance on the optical axis from the object-side surface of the first lens to the imaging plane, and IMG HT may be a half of a diagonal length of the imaging plane. Accordingly, resolution of an image may be improved, and the optical imaging system may be reduced in size.

In an example embodiment, the optical imaging system may satisfy a condition of 0.4<TTL/(2×IMG HT)<0.6.

In an example embodiment, the optical imaging system may satisfy a condition of −35<v1−v2≤0. Here, v1 may be an Abbe number of the first lens and v2 may be an Abbe number of the second lens. Accordingly, chromatic aberration may be improved.

In an example embodiment, the optical imaging system may satisfy a condition of n2+n3>3.15. Here, n2 may be a refractive index of the second lens, and n3 may be an Abbe number of the third lens. Accordingly, resolution of an image may be improved, and chromatic aberration may be improved.

In an example embodiment, the optical imaging system may satisfy a condition of −2.5<f−TTL_2<−0.2. Here, f may be a total focal length of the plurality of lenses, and TTL_2 may be a distance on the optical axis from an object-side surface of the second lens to the imaging plane. Accordingly, the optical imaging system may be reduced in size.

In an example embodiment, the optical imaging system may satisfy a condition of 0.05<|f/f1|<1.3. Here, f1 may be a focal length of the first lens. Accordingly, refractive power of the first lens may be appropriately adjusted, thereby minimizing occurrence of aberration.

In an example embodiment, the optical imaging system may satisfy a condition of 0.001<D1/f<0.04. Here, D1 may be a distance on the optical axis between the image-side surface of the first lens and the object-side surface of the second lens. Accordingly, chromatic aberration may be improved.

In an example embodiment, the optical imaging system may satisfy a condition of 0.4<f/f2+f/f3<1.7. Here, f2 may be a focal length of the second lens, and f3 may be a focal length of the third lens. Accordingly, chromatic aberration may be improved.

In an example embodiment, the optical imaging system may satisfy a condition of |R1|>500 mm. R1 may be a radius of curvature of the object-side surface of the first lens. Accordingly, the object-side surface of the first lens may be a plane or may be formed to be close to the plane, thereby reducing a size of the optical imaging system and increasing a degree of design freedom.

In an example embodiment, the optical imaging system may satisfy a condition of 0.9<|(R1+R2)/(R1−R2)|<1.1. R2 may be a radius of curvature of the image-side surface of the first lens. Accordingly, the optical imaging system may be reduced in size.

In an example embodiment, the optical imaging system may satisfy a condition Nfa>NL/2. Nfa may be the number of lenses, among the plurality of lenses, having a focal length greater than an absolute value of a total focal length of the optical imaging system, and NL may be the number of the plurality of lenses. Accordingly, sensitivity may be reduced when each lens is manufactured.

The first lens may have positive or negative refractive power. In addition, the first lens may have a meniscus shape that is convex toward an object side. For example, a paraxial region of the object-side surface of the first lens may have a convex shape, and a paraxial region of the image-side surface of the first lens may have a concave shape.

Alternatively, the first lens may have both surfaces having a convex shape. For example, the object-side surface and the image-side surface of the first lens may each have a convex shape.

The paraxial region of the object-side surface of the first lens may be a plane, or may be formed to be close to the plane.

The second lens may have positive refractive power. In addition, the second lens may have a meniscus shape that is convex toward the object side. For example, a paraxial region of the object-side surface of the second lens may have a convex shape, and a paraxial region of an image-side surface of the second lens may have a concave shape.

In an example embodiment, a focal length of the second lens may have a smallest absolute value, among absolute values of focal lengths of the plurality of lenses of the optical imaging system.

The third lens may have positive or negative refractive power. In addition, the third lens may have a meniscus shape that is convex toward the object side. For example, a paraxial region of an object-side surface of the third lens may have a convex shape, and a paraxial region of an image-side surface of the third lens may have a concave shape.

The fourth lens may have positive refractive power. In addition, the fourth lens may have a meniscus shape that is convex toward the object side. For example, a paraxial region of an object-side surface of the fourth lens may have a convex shape, and a paraxial region of an image-side surface of the fourth lens may have a concave shape.

Alternatively, the fourth lens may have both surfaces having a convex shape. For example, the object-side surface and the image-side surface of the fourth lens may each have a convex shape.

The fifth lens may have positive or negative refractive power. In addition, the fifth lens may have a meniscus shape that is convex toward the object side. For example, a paraxial region of an object-side surface of the fifth lens may have a convex shape, and a paraxial region of an image-side surface of the fifth lens may have a concave shape.

Alternatively, the fifth lens may have a meniscus shape that is convex toward an image side. For example, the paraxial region of the object-side surface of the fifth lens may have a concave shape, and the paraxial region of the image-side surface of the fifth lens may have a convex shape.

Alternatively, the fifth lens may have both surfaces having a concave shape. For example, the paraxial regions of the object-side surface and the image-side surface of the fifth lens may each have a concave shape.

The sixth lens may have positive or negative refractive power. In addition, the sixth lens may have a meniscus shape that is convex toward the object side. For example, a paraxial region of an object-side surface of the sixth lens may have a convex shape, and a paraxial region of an image-side surface of the sixth lens may have a concave shape.

Alternatively, the sixth lens may have a meniscus shape that is convex toward the image side. For example, the paraxial region of the object-side surface of the sixth lens may have a concave shape, and the paraxial region of the image-side surface of the sixth lens may have a convex shape.

Alternatively, the sixth lens may have both surfaces having a convex shape. For example, the paraxial regions of the object-side surface and the image-side surface of the sixth lens may each have a convex shape.

The seventh lens may have positive or negative refractive power. In addition, the seventh lens may have both surfaces having a concave shape. For example, paraxial regions of an object-side surface and an image-side surface of the seventh lens may each have a concave shape.

Alternatively, the seventh lens may have a meniscus shape that is convex toward the object side. For example, the paraxial region of the object-side surface of the seventh lens may have a convex shape, and the paraxial region of the image-side surface of the seventh lens may have a concave shape.

Alternatively, the seventh lens may have a meniscus shape that is convex toward the image side. For example, the paraxial region of the object-side surface of the seventh lens may have a concave shape, and the paraxial region of the image-side surface of the seventh lens may have a convex shape.

Alternatively, the seventh lens may have both surfaces having a convex shape. For example, the paraxial regions of the object-side surface and the image-side surface of the seventh lens may each have a convex shape.

The eighth lens may have positive or negative refractive power. In addition, the eighth lens may have a meniscus shape that is convex toward the object side. For example, a paraxial region of an object-side surface of the eighth lens may have a convex shape, and a paraxial region of an image-side surface of the eighth lens may have a concave shape.

Alternatively, the eighth lens may have a meniscus shape that is convex toward the image side. For example, the paraxial region of the object-side surface of the eighth lens may have a concave shape, and the paraxial region of the image-side surface of the eighth lens may have a convex shape.

Alternatively, the eighth lens may have both surfaces having a concave shape. For example, the paraxial regions of the object-side surface and the image-side surface of the eighth lens may each have a concave shape.

The ninth lens may have positive or negative refractive power. In addition, the ninth lens may have a meniscus shape that is convex toward the object side. For example, a paraxial region of an object-side surface of the ninth lens may have a convex shape, and a paraxial region of an image-side surface of the ninth lens may have a concave shape.

Alternatively, the ninth lens may have both surfaces having a convex shape. For example, the paraxial regions of the object-side surface and the image-side surface of the ninth lens may each have a convex shape.

The tenth lens may have negative refractive power. In addition, the tenth lens may have both surfaces having a concave shape. For example, a paraxial region of an object-side surface and a paraxial region of an image-side surface of the tenth lens may each have a concave shape.

In addition, at least one of an object-side surface and an image-side surface of at least one lens, among the second lens, the fourth lens, and the sixth to tenth lenses, may have at least one inflection point. For example, the paraxial region of the object-side surface of the eighth lens may have a convex shape, and a portion of the object-side surface of the eighth lens, other than the paraxial region, may have a concave shape. The paraxial region of the image-side surface of the eighth lens may have a concave shape, and a portion of the image-side surface of the eighth lens, other than the paraxial region, may have a convex shape.

In addition, at least one of an object-side surface and an image-side surface of a rearmost lens, among the plurality of lenses of the optical imaging system, may have at least one inflection point.

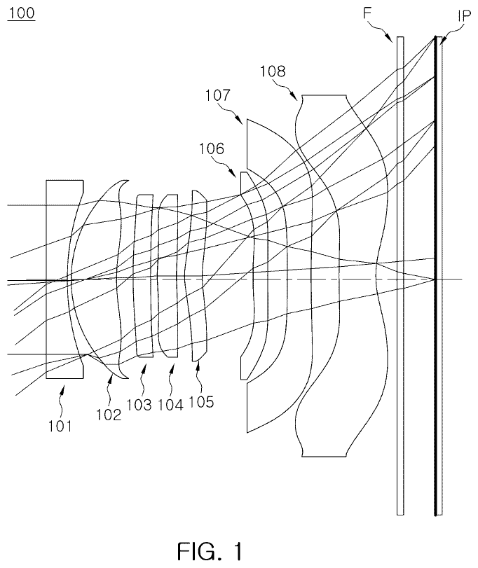

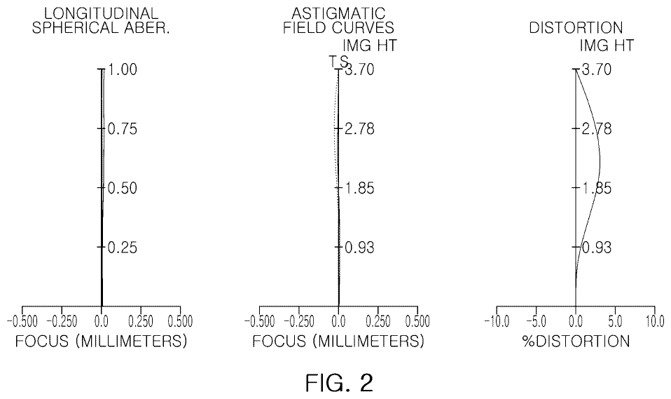

An optical imaging system 100 according to a first example embodiment of the present disclosure will be described with reference to FIGS. 1 and 2.

The optical imaging system 100 according to the first example embodiment of the present disclosure may include a first lens 101, a second lens 102, a third lens 103, a fourth lens 104, a fifth lens 105, a sixth lens 106, a seventh lens 107, and an eighth lens 108, and may further include a filter F and an image sensor.

The optical imaging system 100 according to the first example embodiment of the present disclosure may form a focal point on an imaging plane IP.

Lens properties (a radius of curvature, a thickness of a lens or a distance between lenses, an index (refractive index), and an Abbe number) of each lens are indicated in Table 1.

TABLE 1

| Surface | | Radius of | Thickness | | Abbe |
|---|---|---|---|---|---|
| No. | | Curvature | or Distance | Index | number |
| S1 | First | Infinity | 0.300 | 1.646 | 23.5 |
| | lens | | | | |
| S2 | | 4.000 | 0.050 | | |
| S3 | Second | 1.724 | 0.711 | 1.547 | 56.1 |
| | lens | | | | |
| S4 | | 7.031 | 0.242 | | |
| S5 | Third | 5.123 | 0.256 | 1.669 | 20.4 |
| | lens | | | | |
| S6 | | 6.543 | 0.100 | | |
| S7 | Fourth | 3.768 | 0.311 | 1.547 | 56.1 |
| | lens | | | | |
| S8 | | 4.517 | 0.107 | | |
| S9 | Fifth | 2.339 | 0.275 | 1.547 | 56.1 |
| | lens | | | | |
| S10 | | 5.902 | 0.763 | | |
| S11 | Sixth | 10.225 | 0.212 | 1.669 | 20.4 |
| | lens | | | | |
| S12 | | 31.628 | 0.281 | | |
| S13 | Seventh | −10.458 | 0.357 | 1.646 | 23.5 |
| | lens | | | | |
| S14 | | 9.455 | 0.424 | | |
| S15 | Eighth | 4.421 | 0.568 | 1.537 | 55.7 |
| | lens | | | | |
| S16 | | 1.837 | 0.310 | | |
| S17 | Filter | Infinity | 0.110 | 1.519 | 64.2 |
| S18 | | Infinity | 0.476 | | |
| S19 | Imaging | Infinity | | | |
| | plane | | | | |

In the first example embodiment of the present disclosure, the first lens 101 may have negative refractive power, a paraxial region of an object-side surface of the first lens 101 may be a plane, and a paraxial region of an image-side surface of the first lens 101 may have a concave shape.

The second lens 102 may have positive refractive power, a paraxial region of an object-side surface of the second lens 102 may have a convex shape, and a paraxial region of an image-side surface of the second lens 102 may have a concave shape.

The third lens 103 may have positive refractive power, a paraxial region of an object-side surface of the third lens 103 may have a convex shape, and a paraxial region of an image-side surface of the third lens 103 may have a concave shape.

The fourth lens 104 may have positive refractive power, a paraxial region of an object-side surface of the fourth lens 104 may have a convex shape, and a paraxial region of an image-side surface of the fourth lens 104 may have a concave shape.

The fifth lens 105 may have positive refractive power, a paraxial region of an object-side surface of the fifth lens 105 may have a convex shape, and a paraxial region of an image-side surface of the fifth lens 105 may have a concave shape.

The sixth lens 106 may have positive refractive power, a paraxial region of an object-side surface of the sixth lens 106 may have a convex shape, and a paraxial region of an image-side surface of the sixth lens 106 may have a concave shape.

The seventh lens 107 may have negative refractive power, and paraxial regions of an object-side surface and an image-side surface of the seventh lens 107 may each have a concave shape.

The eighth lens 108 may have negative refractive power, a paraxial region of an object-side surface of the eighth lens 108 may have a convex shape, and a paraxial region of an image-side surface of the eighth lens 108 may have a concave shape.

In addition, at least one of an object-side surface and an image-side surface of at least one lens, among the second lens 102, the seventh lens 107, and the eighth lens 108, may have at least one inflection point.

A surface of each of the first to eighth lenses 101 to 108 may have an aspherical coefficient, as indicated in Table 2. For example, the object-side surface of the first lens 101 may be a spherical surface, and the object-side surface of the first lens 101 and the object-side surfaces and the image-side surfaces of the second to eighth lenses 102 to 108 may all be aspherical surfaces.

TABLE 2

| | S1 | S2 | S3 | S4 | S5 | S6 | S7 | S8 |
|---|---|---|---|---|---|---|---|---|
| Conic | 0.000E+00 | 0.000E+00 | −1.734E+00 | −1.651E+01 | −3.356E+01 | 1.408E+00 | −1.047E+01 | −5.167E+01 |
| constant (K) | | | | | | | | |
| Fourth-order | 0.000E+00 | −3.952E−03 | 2.118E−02 | −4.949E−03 | −2.517E−02 | −6.377E−02 | 1.289E−02 | −6.901E−02 |
| coefficient (A) | | | | | | | | |
| Sixth-order | 0.000E+00 | 6.584E−03 | −1.493E−02 | −7.250E−03 | −2.255E−02 | −3.856E−02 | −6.090E−02 | 8.131E−02 |
| coefficient (B) | | | | | | | | |
| Eighth-order | 0.000E+00 | 1.980E−03 | 7.543E−02 | −5.368E−02 | −5.811E−02 | 5.481E−02 | 7.890E−02 | −1.842E−01 |
| coefficient (C) | | | | | | | | |
| Tenth-order | 0.000E+00 | −1.297E−04 | −1.954E−01 | 1.080E−01 | 2.147E−01 | −8.969E−02 | −2.891E−01 | 1.830E−01 |
| coefficient (D) | | | | | | | | |
| Twelfth-order | 0.000E+00 | −3.052E−04 | 3.034E−01 | −1.170E−01 | −3.094E−01 | 3.172E−01 | 6.707E−01 | −1.672E−01 |
| coefficient (E) | | | | | | | | |
| Fourteenth-order | 0.000E+00 | −3.595E−05 | −2.906E−01 | 6.955E−02 | 2.674E−01 | −5.258E−01 | −9.091E−01 | 1.311E−01 |
| coefficient (F) | | | | | | | | |
| Sixteenth-order | 0.000E+00 | 8.208E−05 | 1.658E−01 | −1.643E−02 | −1.192E−01 | 4.570E−01 | 7.168E−01 | −3.424E−02 |
| coefficient (G) | | | | | | | | |
| Eighteenth-order | 0.000E+00 | 8.182E−13 | −5.185E−02 | −2.153E−03 | 1.987E−02 | −1.965E−01 | −2.930E−01 | −1.420E−02 |
| coefficient (H) | | | | | | | | |
| Twentieth-order | 0.000E+00 | 3.843E−14 | 6.831E−03 | 1.228E−03 | 4.134E−04 | 3.238E−02 | 4.774E−02 | 7.662E−03 |
| coefficient (J) | | | | | | | | |

| | S9 | S10 | S11 | S12 | S13 | S14 | S15 | S16 |
|---|---|---|---|---|---|---|---|---|
| Conic | −3.493E−01 | 3.945E+00 | 0.000E+00 | 0.000E+00 | 0.000E+00 | 0.000E+00 | −1.353E+01 | −9.037E+00 |
| constant (K) | | | | | | | | |
| Fourth-order | −1.691E−01 | −3.569E−02 | −5.223E−03 | 9.024E−02 | 1.331E−01 | 5.553E−02 | −1.754E−01 | −6.415E−02 |
| coefficient (A) | | | | | | | | |
| Sixth-order | 1.902E−01 | 2.802E−02 | −1.238E−01 | −2.443E−01 | −2.378E−01 | −9.769E−02 | 1.065E−01 | 2.360E−02 |
| coefficient (B) | | | | | | | | |
| Eighth-order | −4.380E−01 | −1.343E−01 | −1.550E−02 | 1.660E−01 | 1.757E−01 | 4.990E−02 | −5.840E−02 | −7.400E−03 |
| coefficient (C) | | | | | | | | |
| Tenth-order | 9.750E−01 | 4.229E−01 | 3.248E−01 | 1.803E−02 | −8.963E−02 | −9.086E−03 | 1.951E−02 | 1.395E−03 |
| coefficient (D) | | | | | | | | |
| Twelfth-order | −1.616E+00 | −7.348E−01 | −5.871E−01 | −1.406E−01 | 3.739E−02 | −2.424E−03 | −3.590E−03 | −1.348E−04 |
| coefficient (E) | | | | | | | | |
| Fourteenth-order | 1.713E+00 | 7.372E−01 | 5.617E−01 | 1.338E−01 | −1.171E−02 | 1.658E−03 | 3.586E−04 | 1.406E−06 |
| coefficient (F) | | | | | | | | |
| Sixteenth-order | −1.070E+00 | −4.252E−01 | −3.135E−01 | −6.605E−02 | 1.437E−03 | −3.710E−04 | −1.781E−05 | 8.792E−07 |
| coefficient (G) | | | | | | | | |
| Eighteenth-order | 3.604E−01 | 1.304E−01 | 9.558E−02 | 1.724E−02 | 2.344E−04 | 3.917E−05 | 3.237E−07 | −5.213E−08 |
| coefficient (H) | | | | | | | | |
| Twentieth-order | −5.116E−02 | −1.672E−02 | −1.230E−02 | −1.847E−03 | −5.695E−05 | −1.635E−06 | 0.000E+00 | 0.000E+00 |
| coefficient (J) | | | | | | | | |

In addition, the optical imaging system configured as described above may have aberration properties as illustrated in FIG. 2.

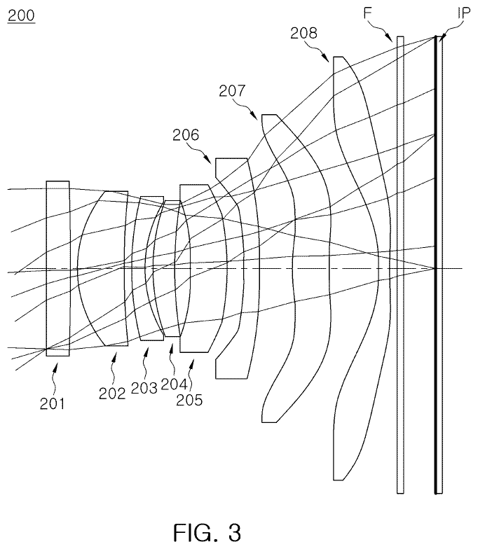

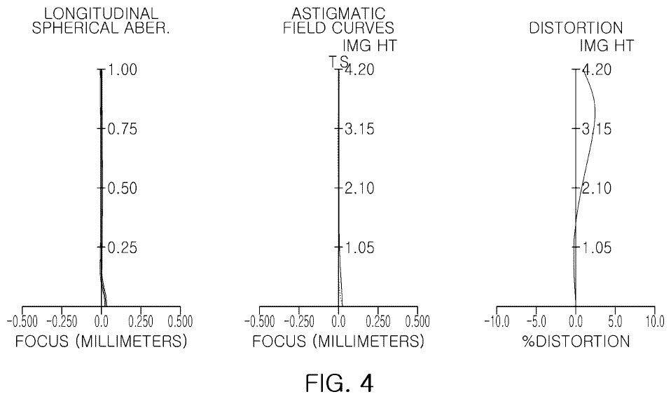

An optical imaging system 200 according to a second example embodiment of the present disclosure will be described with reference to FIGS. 3 and 4.

The optical imaging system 200 according to the second example embodiment of the present disclosure may include a first lens 201, a second lens 202, a third lens 203, a fourth lens 204, a fifth lens 205, a sixth lens 206, a seventh lens 207, and an eighth lens 208, and may further include a filter F and an image sensor.

The optical imaging system 200 according to the second example embodiment of the present disclosure may form a focal point on an imaging plane IP.

Lens properties (a radius of curvature, a thickness of a lens or a distance between lenses, an index, and an Abbe number) of each lens are indicated in Table 3.

TABLE 3

| Surface | | Radius of | Thickness | | Abbe |
|---|---|---|---|---|---|
| No. | | Curvature | or Distance | Index | number |
| S1 | First lens | Infinity | 0.400 | 1.547 | 56.1 |
| S2 | | −40.000 | 0.100 | | |
| S3 | Second | 2.013 | 0.792 | 1.547 | 56.1 |
| | lens | | | | |
| S4 | | 8.925 | 0.179 | | |
| S5 | Third | 5.506 | 0.233 | 1.679 | 19.2 |
| | lens | | | | |
| S6 | | 2.847 | 0.137 | | |
| S7 | Fourth | 4.581 | 0.383 | 1.537 | 55.7 |
| | lens | | | | |
| S8 | | 6.223 | 0.264 | | |
| S9 | Fifth lens | −16.753 | 0.621 | 1.679 | 19.2 |
| S10 | | −41.803 | 0.302 | | |
| S11 | Sixth | 45.068 | 0.296 | 1.620 | 26.0 |
| | lens | | | | |
| S12 | | 47.630 | 0.569 | | |
| S13 | Seventh | 3.875 | 0.630 | 1.571 | 37.4 |
| | lens | | | | |
| S14 | | 6.416 | 0.863 | | |
| S15 | Eighth | 47.188 | 0.185 | 1.537 | 55.7 |
| | lens | | | | |
| S16 | | 2.675 | 0.132 | | |
| S17 | Filter | Infinity | 0.110 | 1.519 | 64.2 |
| S18 | | Infinity | 0.544 | | |
| S19 | Imaging | Infinity | | | |
| | plane | | | | |

In the second example embodiment of the present disclosure, the first lens 201 may have positive refractive power, an object-side surface of the first lens 201 may be a plane, and a paraxial region of an image-side surface of the first lens 201 may have a convex shape.

The second lens 202 may have positive refractive power, a paraxial region of an object-side surface of the second lens 202 may have a convex shape, and a paraxial region of an image-side surface of the second lens 202 may have a concave shape.

The third lens 203 may have negative refractive power, a paraxial region of an object-side surface of the third lens 203 may have a convex shape, and a paraxial region of an image-side surface of the third lens 203 may have a concave shape.

The fourth lens 204 may have positive refractive power, a paraxial region of an object-side surface of the fourth lens 204 may have a convex shape, and a paraxial region of an image-side surface of the fourth lens 204 may have a concave shape.

The fifth lens 205 may have negative refractive power, a paraxial region of an object-side surface of the fifth lens 205 may have a concave shape, and a paraxial region of an image-side surface of the fifth lens 205 may have a convex shape.

The sixth lens 206 may have positive refractive power, a paraxial region of an object-side surface of the sixth lens 206 may have a convex shape, and a paraxial region of an image-side surface of the sixth lens 206 may have a concave shape.

The seventh lens 207 may have positive refractive power, a paraxial region of an object-side surface of the seventh lens 207 may have a convex shape, and a paraxial region of an image-side surface of the seventh lens 207 may have a concave shape.

The eighth lens 208 may have negative refractive power, a paraxial region of an object-side surface of the eighth lens 208 may have a convex shape, and a paraxial region of an image-side surface of the eighth lens 208 may have a concave shape.

In addition, at least one of an object-side surface and an image-side surface of at least one lens, among the sixth to eighth lenses 206 to 208, may have at least one inflection point.

A surface of each of the first to eighth lenses 201 to 208 may have an aspherical coefficient, as indicated in Table 4. For example, the object-side surface of the first lens 201 may be a spherical surface, and the image-side surface of the first lens 201 and the object-side surfaces and the image-side surfaces of the second to eighth lenses 202 to 208 may all be aspherical surfaces.

TABLE 4

| | S1 | S2 | S3 | S4 | S5 | S6 | S7 | S8 |
|---|---|---|---|---|---|---|---|---|
| Conic | 0.000E+00 | −9.000E+01 | −2.244E−01 | −6.221E+00 | 9.432E+00 | 3.496E+00 | 5.797E+00 | 6.678E+00 |
| constant (K) | | | | | | | | |
| Fourth-order | 0.000E+00 | 1.013E−02 | 2.391E−02 | −1.538E−02 | −3.790E−03 | −1.711E−02 | 1.965E−03 | −1.238E−02 |
| coefficient (A) | | | | | | | | |
| Sixth-order | 0.000E+00 | −3.029E−02 | −1.700E−01 | 1.447E−01 | −8.581E−02 | 1.217E−01 | −8.108E−02 | 2.142E−02 |
| coefficient (B) | | | | | | | | |
| Eighth-order | 0.000E+00 | 1.021E−01 | 1.026E+00 | −1.051E+00 | 7.399E−01 | −1.681E+00 | 4.199E−01 | −3.188E−01 |
| coefficient (C) | | | | | | | | |
| Tenth-order | 0.000E+00 | −2.704E−01 | −4.025E+00 | 4.856E+00 | −3.604E+00 | 1.278E+01 | −9.907E−01 | 1.838E+00 |
| coefficient (D) | | | | | | | | |
| Twelfth-order | 0.000E+00 | 5.125E−01 | 1.063E+01 | −1.484E+01 | 1.175E+01 | −6.194E+01 | −2.295E+00 | −6.189E+00 |
| coefficient (E) | | | | | | | | |
| Fourteenth-order | 0.000E+00 | −6.905E−01 | −1.958E+01 | 3.133E+01 | −2.665E+01 | 2.038E+02 | 2.500E+01 | 1.329E+01 |
| coefficient (F) | | | | | | | | |
| Sixteenth-order | 0.000E+00 | 6.667E−01 | 2.578E+01 | −4.690E+01 | 4.313E+01 | −4.705E+02 | −8.883E+01 | −1.862E+01 |
| coefficient (G) | | | | | | | | |
| Eighteenth-order | 0.000E+00 | −4.640E−01 | −2.459E+01 | 5.047E+01 | −5.048E+01 | 7.755E+02 | 1.869E+02 | 1.672E+01 |
| coefficient (H) | | | | | | | | |
| Twentieth-order | 0.000E+00 | 2.323E−01 | 1.703E+01 | −3.917E+01 | 4.279E+01 | −9.169E+02 | −2.591E+02 | −8.716E+00 |
| coefficient (J) | | | | | | | | |
| Twenty | 0.000E+00 | −8.259E−02 | −8.475E+00 | 2.171E+01 | −2.599E+01 | 7.712E+02 | 2.436E+02 | 1.472E+00 |
| second-order | | | | | | | | |
| coefficient (L) | | | | | | | | |
| Twenty | 0.000E+00 | 2.028E−02 | 2.955E+00 | −8.377E+00 | 1.101E+01 | −4.501E+02 | −1.540E+02 | 1.104E+00 |
| fourth-order | | | | | | | | |
| coefficient (M) | | | | | | | | |
| Twenty | 0.000E+00 | −3.261E−03 | −6.851E−01 | 2.135E+00 | −3.083E+00 | 1.732E+02 | 6.282E+01 | −7.864E−01 |
| sixth-order | | | | | | | | |
| coefficient (N) | | | | | | | | |
| Twenty | 0.000E+00 | 3.082E−04 | 9.489E−02 | −3.230E−01 | 5.124E−01 | −3.947E+01 | −1.492E+01 | 2.017E−01 |
| eighth-order | | | | | | | | |
| coefficient (O) | | | | | | | | |
| Thirtieth-order | 0.000E+00 | −1.297E−05 | −5.942E−03 | 2.193E−02 | −3.823E−02 | 4.033E+00 | 1.569E+00 | −1.908E−02 |
| coefficient (P) | | | | | | | | |

| | S9 | S10 | S11 | S12 | S13 | S14 | S15 | S16 |
|---|---|---|---|---|---|---|---|---|
| Conic | −8.950E+01 | −1.278E+01 | −9.000E+01 | −3.126E+00 | −7.249E−01 | −2.378E+01 | 4.583E+01 | −2.557E+01 |
| constant (K) | | | | | | | | |
| Fourth-order | −4.916E−02 | −5.166E−02 | −6.823E−02 | −8.661E−02 | −8.986E−02 | −3.932E−02 | −3.323E−01 | −2.241E−01 |
| coefficient (A) | | | | | | | | |
| Sixth-order | −5.610E−02 | 1.624E−02 | −7.390E−03 | 2.420E−02 | −8.456E−03 | −2.604E−02 | 2.852E−01 | 1.766E−01 |
| coefficient (B) | | | | | | | | |
| Eighth-order | 2.738E−01 | −2.029E−01 | 8.143E−02 | 8.268E−02 | 3.625E−02 | 3.906E−02 | −1.496E−01 | −8.204E−02 |
| coefficient (C) | | | | | | | | |
| Tenth-order | −1.126E+00 | 8.463E−01 | −1.479E−01 | −1.760E−01 | −3.208E−02 | −2.834E−02 | 5.399E−02 | 2.534E−02 |
| coefficient (D) | | | | | | | | |
| Twelfth-order | 3.175E+00 | −2.151E+00 | 1.254E−01 | 1.932E−01 | 1.661E−02 | 1.338E−02 | −1.404E−02 | −5.439E−03 |
| coefficient (E) | | | | | | | | |
| Fourteenth-order | −6.250E+00 | 3.626E+00 | −4.176E−02 | −1.367E−01 | −5.440E−03 | −4.430E−03 | 2.713E−03 | 8.218E−04 |
| coefficient (F) | | | | | | | | |
| Sixteenth-order | 8.687E+00 | −4.217E+00 | −1.782E−02 | 6.597E−02 | 1.089E−03 | 1.064E−03 | −3.975E−04 | −8.656E−05 |
| coefficient (G) | | | | | | | | |
| Eighteenth-order | −8.586E+00 | 3.451E+00 | 2.581E−02 | −2.225E−02 | −1.017E−04 | −1.872E−04 | 4.448E−05 | 6.066E−06 |
| coefficient (H) | | | | | | | | |
| Twentieth-order | 6.023E+00 | −1.997E+00 | −1.302E−02 | 5.295E−03 | −7.457E−06 | 2.398E−05 | −3.785E−06 | −2.415E−07 |
| coefficient (J) | | | | | | | | |
| Twenty | −2.964E+00 | 8.104E−01 | 3.796E−03 | −8.844E−04 | 3.664E−06 | −2.199E−06 | 2.409E−07 | 9.573E−10 |
| second-order | | | | | | | | |
| coefficient (L) | | | | | | | | |
| Twenty | 9.971E−01 | −2.247E−01 | −6.919E−04 | 1.015E−04 | −5.173E−07 | 1.400E−07 | −1.111E−08 | 4.569E−10 |
| fourth-order | | | | | | | | |
| coefficient (M) | | | | | | | | |
| Twenty | −2.181E−01 | 4.046E−02 | 7.806E−05 | −7.614E−06 | 3.890E−08 | −5.861E−09 | 3.498E−10 | −2.507E−11 |
| sixth-order | | | | | | | | |
| coefficient (N) | | | | | | | | |
| Twenty | 2.792E−02 | −4.252E−03 | −5.005E−06 | 3.364E−07 | −1.567E−09 | 1.446E−10 | −6.716E−12 | 6.006E−13 |
| eighth-order | | | | | | | | |
| coefficient (O) | | | | | | | | |
| Thirtieth-order | −1.586E−03 | 1.976E−04 | 1.398E−07 | −6.632E−09 | 2.668E−11 | −1.592E−12 | 5.919E−14 | −5.743E−15 |
| coefficient (P) | | | | | | | | |

In addition, the optical imaging system configured as described above may have aberration properties as illustrated in FIG. 4.

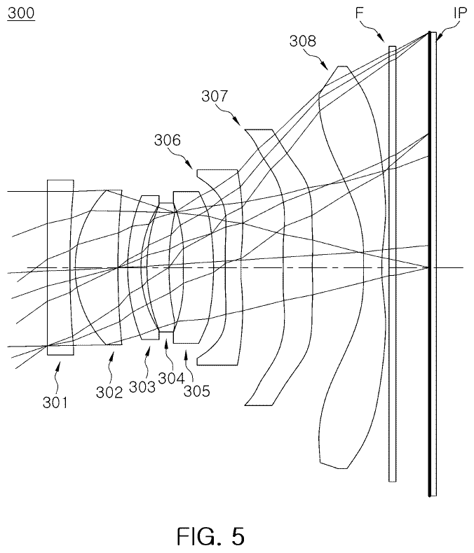

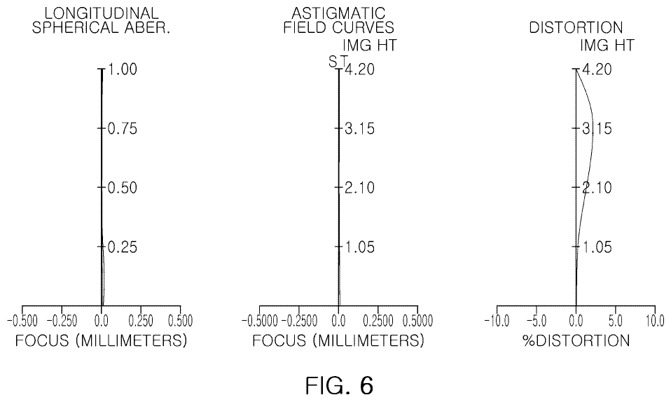

An optical imaging system 300 according to a third example embodiment of the present disclosure will be described with reference to FIGS. 5 and 6.

The optical imaging system 300 according to the third example embodiment of the present disclosure may include a first lens 301, a second lens 302, a third lens 303, a fourth lens 304, a fifth lens 305, a sixth lens 306, a seventh lens 307, and an eighth lens 308, and may further include a filter F and an image sensor.

The optical imaging system 300 according to the third example embodiment of the present disclosure may form a focal point on an imaging plane IP.

Lens properties (a radius of curvature, a thickness of a lens or a distance between lenses, an index, and an Abbe number) of each lens are indicated in Table 5.

TABLE 5

| Surface | | Radius of | Thickness | | Abbe |
|---|---|---|---|---|---|
| No. | | Curvature | or Distance | Index | number |
| S1 | First lens | Infinity | 0.400 | 1.547 | 56.1 |
| S2 | | 19.000 | 0.100 | | |
| S3 | Second | 1.902 | 0.762 | 1.547 | 56.1 |
| | lens | | | | |
| S4 | | 14.060 | 0.149 | | |
| S5 | Third | 5.373 | 0.233 | 1.679 | 19.2 |
| | lens | | | | |
| S6 | | 2.712 | 0.100 | | |
| S7 | Fourth | 3.408 | 0.385 | 1.537 | 55.7 |
| | lens | | | | |
| S8 | | 4.614 | 0.236 | | |
| S9 | Fifth lens | −44.055 | 0.552 | 1.679 | 19.2 |
| S10 | | 120.976 | 0.207 | | |
| S11 | Sixth | 5.655 | 0.294 | 1.620 | 26.0 |
| | lens | | | | |
| S12 | | 6.622 | 0.724 | | |
| S13 | Seventh | 4.511 | 0.523 | 1.571 | 37.4 |
| | lens | | | | |
| S14 | | 7.734 | 0.893 | | |
| S15 | Eighth | 116.666 | 0.328 | 1.537 | 55.7 |
| | lens | | | | |
| S16 | | 2.830 | 0.132 | | |
| S17 | Filter | Infinity | 0.110 | 1.519 | 64.2 |
| S18 | | Infinity | 0.570 | | |
| S19 | Imaging | Infinity | | | |
| | plane | | | | |

In the third example embodiment of the present disclosure, the first lens 301 may have negative refractive power, a paraxial region of an object-side surface of the first lens 301 may be a plane, and a paraxial region of an image-side surface of the first lens 301 may have a concave shape.

The second lens 302 may have positive refractive power, a paraxial region of an object-side surface of the second lens 302 may have a convex shape, and a paraxial region of an image-side surface of the second lens 302 may have a concave shape.

The third lens 303 may have negative refractive power, a paraxial region of an object-side surface of the third lens 303 may have a convex shape, and a paraxial region of an image-side surface of the third lens 303 may have a concave shape.

The fourth lens 304 may have positive refractive power, a paraxial region of an object-side surface of the fourth lens 304 may have a convex shape, and a paraxial region of an image-side surface of the fourth lens 304 may have a concave shape.

The fifth lens 305 may have negative refractive power, and paraxial regions of an object-side surface and an image-side surface of the fifth lens 305 may each have a concave shape.

The sixth lens 306 may have positive refractive power, a paraxial region of an object-side surface of the sixth lens 306 may have a convex shape, and a paraxial region of an image-side surface of the sixth lens 306 may have a concave shape.

The seventh lens 307 may have positive refractive power, a paraxial region of an object-side surface of the seventh lens 307 may have a convex shape, and a paraxial region of an image-side surface of the seventh lens 307 may have a concave shape.

The eighth lens 308 may have negative refractive power, a paraxial region of an object-side surface of the eighth lens 308 may have a convex shape, and a paraxial region of an image-side surface of the eighth lens 308 may have a concave shape.

In addition, at least one of an object-side surface and an image-side surface of at least one lens, among the sixth to eighth lenses 306 to 308, may have at least one inflection point.

A surface of each of the first to eighth lenses 301 to 308 may have an aspherical coefficient, as indicated in Table 6. For example, the object-side surface and the image-side surface of the first lens 301 may both be spherical surfaces, and the object-side surfaces and the image-side surfaces of the second to eighth lens 302 to 308 may all be aspherical surfaces.

TABLE 6

| | S1 | S2 | S3 | S4 | S5 | S6 | S7 | S8 |
|---|---|---|---|---|---|---|---|---|
| Conic | 0.000E+00 | 0.000E+00 | −4.063E−01 | −3.274E+01 | 1.270E+01 | 3.481E+00 | 3.007E+00 | 1.207E+00 |
| constant (K) | | | | | | | | |
| Fourth-order | 0.000E+00 | 0.000E+00 | 5.162E−03 | 4.073E−03 | 7.119E−04 | −1.022E−02 | −1.478E−02 | −9.388E−03 |
| coefficient (A) | | | | | | | | |
| Sixth-order | 0.000E+00 | 0.000E+00 | −6.616E−03 | −1.737E−02 | −2.862E−02 | −5.372E−02 | −3.559E−02 | −6.351E−02 |
| coefficient (B) | | | | | | | | |
| Eighth-order | 0.000E+00 | 0.000E+00 | 1.213E−02 | 1.699E−01 | 2.790E−01 | 8.471E−01 | 3.850E−01 | 8.934E−01 |
| coefficient (C) | | | | | | | | |
| Tenth-order | 0.000E+00 | 0.000E+00 | 3.188E−02 | −1.123E+00 | −1.786E+00 | −7.680E+00 | −2.976E+00 | −8.392E+00 |
| coefficient (D) | | | | | | | | |
| Twelfth-order | 0.000E+00 | 0.000E+00 | −2.569E−01 | 4.482E+00 | 7.372E+00 | 4.279E+01 | 1.536E+01 | 5.162E+01 |
| coefficient (E) | | | | | | | | |
| Fourteenth-order | 0.000E+00 | 0.000E+00 | 7.662E−01 | −1.184E+01 | −2.035E+01 | −1.570E+02 | −5.284E+01 | −2.169E+02 |
| coefficient (F) | | | | | | | | |
| Sixteenth-order | 0.000E+00 | 0.000E+00 | −1.412E+00 | 2.170E+01 | 3.901E+01 | 3.968E+02 | 1.248E+02 | 6.423E+02 |
| coefficient (G) | | | | | | | | |
| Eighteenth-order | 0.000E+00 | 0.000E+00 | 1.777E+00 | −2.826E+01 | −5.297E+01 | −7.087E+02 | −2.060E+02 | −1.360E+03 |
| coefficient (H) | | | | | | | | |
| Twentieth-order | 0.000E+00 | 0.000E+00 | −1.572E+00 | 2.631E+01 | 5.128E+01 | 9.019E+02 | 2.387E+02 | 2.067E+03 |
| coefficient (J) | | | | | | | | |
| Twenty | 0.000E+00 | 0.000E+00 | 9.779E−01 | −1.738E+01 | −3.512E+01 | −8.128E+02 | −1.917E+02 | −2.232E+03 |
| second-order | | | | | | | | |
| coefficient (L) | | | | | | | | |
| Twenty | 0.000E+00 | 0.000E+00 | −4.194E−01 | 7.955E+00 | 1.660E+01 | 5.068E+02 | 1.033E+02 | 1.671E+03 |
| fourth-order | | | | | | | | |
| coefficient (M) | | | | | | | | |
| Twenty | 0.000E+00 | 0.000E+00 | 1.181E−01 | −2.396E+00 | −5.140E+00 | −2.078E+02 | −3.499E+01 | −8.232E+02 |
| sixth-order | | | | | | | | |
| coefficient (N) | | | | | | | | |
| Twenty | 0.000E+00 | 0.000E+00 | −1.963E−02 | 4.271E−01 | 9.345E−01 | 5.041E+01 | 6.530E+00 | 2.401E+02 |
| eighth-order | | | | | | | | |
| coefficient (O) | | | | | | | | |
| Thirtieth-order | 0.000E+00 | 0.000E+00 | 1.462E−03 | −3.411E−02 | −7.531E−02 | −5.479E+00 | −4.786E−01 | −3.138E+01 |
| coefficient (P) | | | | | | | | |

| | S9 | S10 | S11 | S12 | S13 | S14 | S15 | S16 |
|---|---|---|---|---|---|---|---|---|
| Conic | 9.000E+01 | 9.000E+01 | −7.772E+01 | −5.745E+01 | −2.226E+00 | −3.297E+00 | 9.000E+01 | −1.989E+01 |
| constant (K) | | | | | | | | |
| Fourth-order | −4.359E−02 | −8.126E−02 | −9.205E−02 | −9.606E−02 | −1.057E−01 | −8.942E−02 | −2.304E−01 | −1.368E−01 |
| coefficient (A) | | | | | | | | |
| Sixth-order | −1.935E−02 | 6.948E−02 | 1.577E−01 | 1.668E−01 | 4.758E−02 | 4.773E−02 | 2.005E−01 | 1.160E−01 |
| coefficient (B) | | | | | | | | |
| Eighth-order | 2.380E−01 | −1.280E−01 | −3.761E−01 | −2.589E−01 | −2.110E−02 | −2.883E−02 | −1.251E−01 | −6.760E−02 |
| coefficient (C) | | | | | | | | |
| Tenth-order | −2.498E+00 | −1.260E−01 | 6.804E−01 | 3.043E−01 | −1.386E−02 | 5.778E−03 | 5.801E−02 | 2.847E−02 |
| coefficient (D) | | | | | | | | |
| Twelfth-order | 1.404E+01 | 1.236E+00 | −1.135E+00 | −2.752E−01 | 3.522E−02 | 6.872E−03 | −2.047E−02 | −8.903E−03 |
| coefficient (E) | | | | | | | | |
| Fourteenth-order | −5.025E+01 | −3.323E+00 | 1.700E+00 | 1.895E−01 | −3.352E−02 | −7.638E−03 | 5.620E−03 | 2.107E−03 |
| coefficient (F) | | | | | | | | |
| Sixteenth-order | 1.227E+02 | 5.350E+00 | −2.090E+00 | −9.564E−02 | 1.978E−02 | 4.042E−03 | −1.201E−03 | −3.812E−04 |
| coefficient (G) | | | | | | | | |
| Eighteenth-order | −2.111E+02 | −5.816E+00 | 1.966E+00 | 3.299E−02 | −7.850E−03 | −1.348E−03 | 1.969E−04 | 5.267E−05 |
| coefficient (H) | | | | | | | | |
| Twentieth-order | 2.581E+02 | 4.419E+00 | −1.358E+00 | −6.577E−03 | 2.143E−03 | 3.022E−04 | −2.424E−05 | −5.509E−06 |
| coefficient (J) | | | | | | | | |
| Twenty | −2.231E+02 | −2.357E+00 | 6.688E−01 | 1.902E−04 | −4.026E−04 | −4.624E−05 | 2.184E−06 | 4.273E−07 |
| second-order | | | | | | | | |
| coefficient (L) | | | | | | | | |
| Twenty | 1.332E+02 | 8.653E−01 | −2.269E−01 | 2.732E−04 | 5.106E−05 | 4.776E−06 | −1.389E−07 | −2.374E−08 |
| fourth-order | | | | | | | | |
| coefficient (M) | | | | | | | | |
| Twenty | −5.219E+01 | −2.084E−01 | 5.021E−02 | −7.432E−05 | −4.170E−06 | −3.192E−07 | 5.890E−09 | 8.909E−10 |
| sixth-order | | | | | | | | |
| coefficient (N) | | | | | | | | |
| Twenty | 1.207E+01 | 2.966E−02 | −6.504E−03 | 8.630E−06 | 1.979E−07 | 1.248E−08 | −1.491E−10 | −2.016E−11 |
| eighth-order | | | | | | | | |
| coefficient (O) | | | | | | | | |
| Thirtieth-order | −1.249E+00 | −1.889E−03 | 3.738E−04 | −3.966E−07 | −4.140E−09 | −2.173E−10 | 1.704E−12 | 2.075E−13 |
| coefficient (P) | | | | | | | | |

In addition, the optical imaging system configured as described above may have aberration properties as illustrated in FIG. 6.

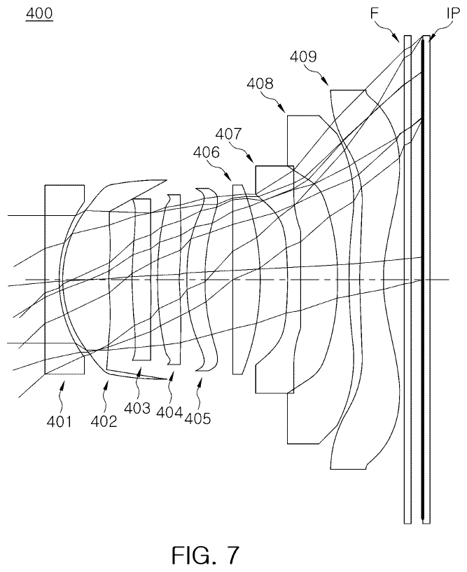

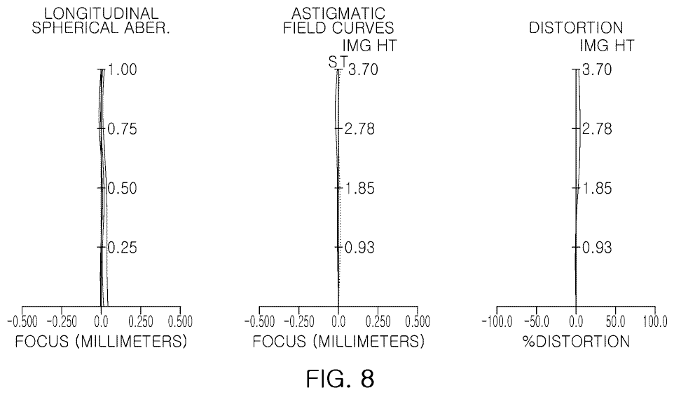

An optical imaging system 400 according to a fourth example embodiment of the present disclosure will be described with reference to FIGS. 7 and 8.

The optical imaging system 400 according to the fourth example embodiment of the present disclosure may include a first lens 401, a second lens 402, a third lens 403, a fourth lens 404, a fifth lens 405, a sixth lens 406, a seventh lens 407, an eighth lens 408, and a ninth lens 409, and may further include a filter F and an image sensor.

The optical imaging system 400 according to the fourth example embodiment of the present disclosure may form a focal point on an imaging plane IP.

Lens properties (a radius of curvature, a thickness of a lens or a distance between lenses, an index, and an Abbe number) of each lens are indicated in Table 7.

TABLE 7

| Surface | | Radius of | Thickness | | Abbe |
|---|---|---|---|---|---|
| No. | | Curvature | or Distance | Index | number |
| S1 | First | Infinity | 0.200 | 1.646 | 23.5 |
| | lens | | | | |
| S2 | | 2.000 | 0.050 | | |
| S3 | Second | 1.483 | 0.695 | 1.547 | 56.1 |
| | lens | | | | |
| S4 | | 21.485 | 0.324 | | |
| S5 | Third | 4.918 | 0.286 | 1.669 | 20.4 |
| | lens | | | | |
| S6 | | 13.837 | 0.100 | | |
| S7 | Fourth | 3.158 | 0.315 | 1.547 | 56.1 |
| | lens | | | | |
| S8 | | 3.268 | 0.121 | | |
| S9 | Fifth | 1.821 | 0.270 | 1.547 | 56.1 |
| | lens | | | | |
| S10 | | 3.406 | 0.364 | | |
| S11 | Sixth | 15.328 | 0.433 | 1.537 | 55.7 |
| | lens | | | | |
| S12 | | −5.125 | 0.400 | | |
| S13 | Seventh | −11.231 | 0.200 | 1.669 | 20.4 |
| | lens | | | | |
| S14 | | −96.012 | 0.531 | | |
| S15 | Eighth | −4.133 | 0.200 | 1.646 | 23.5 |
| | lens | | | | |
| S16 | | 12.363 | 0.133 | | |
| S17 | Ninth | 4.003 | 0.360 | 1.537 | 55.7 |
| | lens | | | | |
| S18 | | 1.927 | 0.310 | | |
| S19 | Filter | Infinity | 0.110 | 1.519 | 64.2 |
| 21 | | Infinity | 0.157 | | |
| Image | Imaging | Infinity | | | |
| | plane | | | | |

In the fourth example embodiment of the present disclosure, the first lens 401 may have negative refractive power, a paraxial region of an object-side surface of the first lens 401 may be a plane, and a paraxial region of an image-side surface of the first lens 401 may have a concave shape.

The second lens 402 may have positive refractive power, a paraxial region of an object-side surface of the second lens 402 may have a convex shape, and a paraxial region of an image-side surface of the second lens 402 may have a concave shape.

The third lens 403 may have positive refractive power, a paraxial region of an object-side surface of the third lens 403 may have a convex shape, and a paraxial region of an image-side surface of the third lens 403 may have a concave shape.

The fourth lens 404 may have positive refractive power, a paraxial region of an object-side surface of the fourth lens 404 may have a convex shape, and a paraxial region of an image-side surface of the fourth lens 404 may have a concave shape.

The fifth lens 405 may have positive refractive power, a paraxial region of an object-side surface of the fifth lens 405 may have a convex shape, and a paraxial region of an image-side surface of the fifth lens 405 may have a concave shape.

The sixth lens 406 may have positive refractive power, paraxial regions of an object-side surface and an image-side surface of the sixth lens 406 may each have a convex shape.

The seventh lens 407 may have negative refractive power, a paraxial region of an object-side surface of the seventh lens 407 may have a concave shape, and a paraxial region of an image-side surface of the seventh lens 407 may have a convex shape.

The eighth lens 408 may have negative refractive power, paraxial regions of an object-side surface and an image-side surface of the eighth lens 408 may each have a concave shape.

The ninth lens 409 may have negative refractive power, a paraxial region of an object-side surface of the ninth lens 409 may have a convex shape, and a paraxial region of an image-side surface of the ninth lens 409 may have a concave shape.

In addition, at least one of an object-side surface and an image-side surface of at least one lens, among the seventh to ninth lenses 407 to 409, may have at least one inflection point.

A surface of each of the first to ninth lenses 401 to 409 may have an aspherical coefficient, as indicated in Table 8. For example, the object-side surface of the first lens 401 may be a spherical surface, and the image-side surface of the first lens 401 and the object-side surfaces and the image-side surfaces of the second to ninth lenses 402 to 409 may all be aspherical surfaces.

TABLE 8

| | S1 | S2 | S3 | S4 | S5 | S6 |
|---|---|---|---|---|---|---|
| Conic | 0.000E+00 | 0.000E+00 | −1.656E+00 | 3.393E+01 | −2.957E+01 | 1.899E−01 |
| constant (K) | | | | | | |
| Fourth-order | 0.000E+00 | −2.119E−02 | 1.319E−02 | −3.090E−03 | −2.693E−03 | −6.053E−02 |
| coefficient (A) | | | | | | |
| Sixth-order | 0.000E+00 | 1.166E−02 | −3.612E−02 | 4.143E−04 | −5.293E−02 | 4.854E−02 |
| coefficient (B) | | | | | | |
| Eighth-order | 0.000E+00 | 5.665E−03 | 1.885E−01 | −8.835E−02 | 3.444E−02 | −5.357E−01 |
| coefficient (C) | | | | | | |
| Tenth-order | 0.000E+00 | 8.367E−04 | −4.768E−01 | 2.079E−01 | −3.746E−02 | 2.012E+00 |
| coefficient (D) | | | | | | |
| Twelfth-order | 0.000E+00 | −2.795E−04 | 7.724E−01 | −2.684E−01 | −2.052E−01 | −4.475E+00 |
| coefficient (E) | | | | | | |
| Fourteenth-order | 0.000E+00 | 1.577E−04 | −7.932E−01 | 1.821E−01 | 7.768E−01 | 6.221E+00 |
| coefficient (F) | | | | | | |
| Sixteenth-order | 0.000E+00 | 8.365E−05 | 4.946E−01 | −4.719E−02 | −1.046E+00 | −5.184E+00 |
| coefficient (G) | | | | | | |
| Eighteenth-order | 0.000E+00 | 8.702E−13 | −1.695E−01 | −7.680E−03 | 6.636E−01 | 2.368E+00 |
| coefficient (H) | | | | | | |
| Twentieth-order | 0.000E+00 | 3.942E−14 | 2.425E−02 | 4.503E−03 | −1.644E−01 | −4.512E−01 |
| coefficient (J) | | | | | | |

| | S7 | S8 | S9 | S10 | S11 | S12 |
|---|---|---|---|---|---|---|
| Conic | −1.267E+01 | −5.060E+01 | −3.900E−01 | 3.042E+00 | 0.000E+00 | 0.000E+00 |
| constant (K) | | | | | | |
| Fourth-order | −3.477E−03 | −9.089E−03 | −1.682E−01 | −2.927E−02 | −6.939E−03 | 1.607E−03 |
| coefficient (A) | | | | | | |
| Sixth-order | 4.708E−02 | −1.535E−01 | 2.034E−01 | 2.642E−02 | −3.320E−04 | −2.297E−03 |
| coefficient (B) | | | | | | |
| Eighth-order | −4.711E−01 | 2.876E−01 | −4.886E−01 | −1.277E−01 | 7.286E−04 | −2.072E−03 |
| coefficient (C) | | | | | | |
| Tenth-order | 1.385E+00 | −6.359E−01 | 9.095E−01 | 2.653E−01 | 1.826E−04 | −8.726E−04 |
| coefficient (D) | | | | | | |
| Twelfth-order | −2.570E+00 | 1.012E+00 | −1.252E+00 | −3.658E−01 | −1.243E−04 | −1.287E−04 |
| coefficient (E) | | | | | | |
| Fourteenth-order | 3.106E+00 | −1.052E+00 | 1.216E+00 | 3.522E−01 | −2.208E−04 | 8.751E−05 |
| coefficient (F) | | | | | | |
| Sixteenth-order | −2.328E+00 | 7.163E−01 | −7.510E−01 | −2.164E−01 | −1.246E−13 | 8.732E−14 |
| coefficient (G) | | | | | | |
| Eighteenth-order | 9.872E−01 | −2.936E−01 | 2.595E−01 | 7.338E−02 | −8.293E−15 | 1.058E−14 |
| coefficient (H) | | | | | | |
| Twentieth-order | −1.793E−01 | 5.654E−02 | −3.827E−02 | −1.057E−02 | −3.991E−16 | 7.825E−16 |
| coefficient (J) | | | | | | |

| | S13 | S14 | S15 | S16 | S17 | S18 |
|---|---|---|---|---|---|---|
| Conic | 0.000E+00 | 0.000E+00 | 0.000E+00 | 0.000E+00 | −7.382E+00 | −8.101E+00 |
| constant (K) | | | | | | |
| Fourth-order | −1.352E−03 | 8.352E−02 | 1.173E−01 | 4.431E−02 | −1.994E−01 | −1.030E−01 |
| coefficient (A) | | | | | | |
| Sixth-order | −2.400E−01 | −2.452E−01 | −1.887E−01 | −5.067E−02 | 2.567E−01 | 9.274E−02 |
| coefficient (B) | | | | | | |
| Eighth-order | 3.871E−01 | 3.372E−01 | 1.302E−01 | 4.319E−03 | −1.825E−01 | −4.919E−02 |
| coefficient (C) | | | | | | |
| Tenth-order | −5.234E−01 | −4.098E−01 | −7.850E−02 | 1.238E−02 | 7.050E−02 | 1.538E−02 |
| coefficient (D) | | | | | | |
| Twelfth-order | 4.015E−01 | 3.713E−01 | 6.940E−02 | −7.473E−03 | −1.566E−02 | −2.949E−03 |
| coefficient (E) | | | | | | |
| Fourteenth-order | −9.402E−02 | −2.219E−01 | −5.462E−02 | 2.108E−03 | 2.004E−03 | 3.414E−04 |
| coefficient (F) | | | | | | |
| Sixteenth-order | −8.251E−02 | 8.170E−02 | 2.547E−02 | −3.326E−04 | −1.374E−04 | −2.194E−05 |
| coefficient (G) | | | | | | |
| Eighteenth-order | 6.432E−02 | −1.675E−02 | −6.254E−03 | 2.843E−05 | 3.902E−06 | 6.016E−07 |
| coefficient (H) | | | | | | |
| Twentieth-order | −1.347E−02 | 1.465E−03 | 6.281E−04 | −1.033E−06 | 0.000E+00 | 0.000E+00 |
| coefficient (J) | | | | | | |

In addition, the optical imaging system configured as described above may have aberration properties as illustrated in FIG. 8.

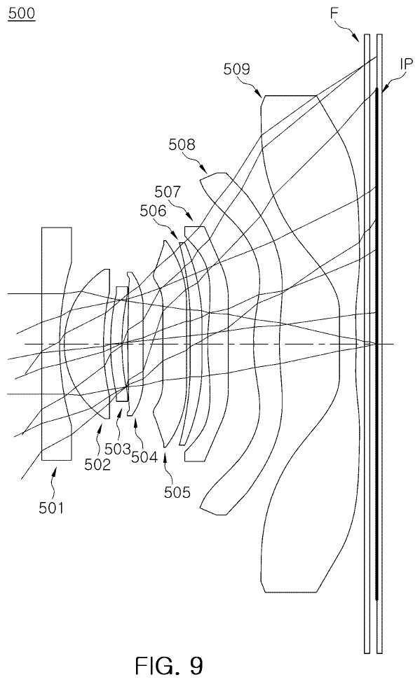

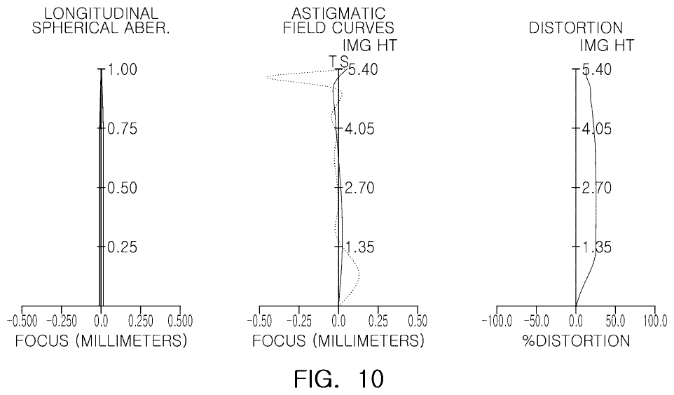

An optical imaging system 500 according to a fifth example embodiment of the present disclosure will be described with reference to FIGS. 9 and 10.

The optical imaging system 500 according to the fifth example embodiment of the present disclosure may include a first lens 501, a second lens 502, a third lens 503, a fourth lens 504, a fifth lens 505, a sixth lens 506, a seventh lens 507, an eighth lens 508, and a ninth lens 509, and may further include a filter F and an image sensor.

The optical imaging system 500 according to the fifth example embodiment of the present disclosure may form a focal point on an imaging plane IP.

Lens properties (a radius of curvature, a thickness of a lens or a distance between lenses, an index, and an Abbe number) of each lens are indicated in Table 9.

TABLE 9

| Surface | | Radius of | Thickness | | Abbe |
|---|---|---|---|---|---|
| No. | | Curvature | or Distance | Index | number |
| S1 | First lens | Infinity | 0.300 | 1.547 | 56.1 |
| S2 | | 5.106 | 0.100 | | |
| S3 | Second | 1.661 | 0.763 | 1.547 | 56.1 |
| | lens | | | | |
| S4 | | 11.903 | 0.100 | | |
| S5 | Third | 9.578 | 0.203 | 1.679 | 19.2 |
| | lens | | | | |
| S6 | | 5.022 | 0.100 | | |
| S7 | Fourth | 7.981 | 0.292 | 1.537 | 55.7 |
| | lens | | | | |
| S8 | | −19.078 | 0.382 | | |
| S9 | Fifth lens | −186.643 | 0.408 | 1.620 | 26.0 |
| S10 | | 18.752 | 0.100 | | |
| S11 | Sixth | −5.543 | 0.200 | 1.620 | 26.0 |
| | lens | | | | |
| S12 | | −8.720 | 0.100 | | |
| S13 | Seventh | 6.667 | 0.360 | 1.571 | 37.4 |
| | lens | | | | |
| S14 | | 21.777 | 0.479 | | |
| S15 | Eighth | 2.989 | 0.485 | 1.547 | 56.1 |
| | lens | | | | |
| S16 | | 4.063 | 1.084 | | |
| S17 | Ninth | 3.789 | 0.350 | 1.537 | 55.7 |
| | lens | | | | |
| S18 | | −2.598 | 0.104 | | |
| S19 | Filter | Infinity | 0.110 | 1.519 | 64.2 |
| 21 | | Infinity | 0.124 | | |
| Image | Imaging | Infinity | | | |
| | plane | | | | |

In the fifth example embodiment of the present disclosure, the first lens 501 may have negative refractive power, a paraxial region of an object-side surface of the first lens 501 may be a plane, and a paraxial region of an image-side surface of the first lens 501 may have a concave shape.

The second lens 502 may have positive refractive power, a paraxial region of an object-side surface of the second lens 502 may have a convex shape, and a paraxial region of an image-side surface of the second lens 502 may have a concave shape.

The third lens 503 may have negative refractive power, a paraxial region of an object-side surface of the third lens 503 may have a convex shape, and a paraxial region of an image-side surface of the third lens 503 may have a concave shape.

The fourth lens 504 may have positive refractive power, paraxial regions of an object-side surface and an image-side surface of the fourth lens 504 may each have a convex shape.

The fifth lens 505 may have negative refractive power, and paraxial regions of an object-side surface and an image-side surface of the fifth lens 505 may each have a concave shape.

The sixth lens 506 may have negative refractive power, a paraxial region of an object-side surface of the sixth lens 506 may have a concave shape, and a paraxial region of an image-side surface of the sixth lens 506 may have a convex shape.

The seventh lens 507 may have positive refractive power, a paraxial region of an object-side surface of the seventh lens 507 may have a convex shape, and a paraxial region of an image-side surface of the seventh lens 507 may have a concave shape.

The eighth lens 508 may have negative refractive power, a paraxial region of an object-side surface of the eighth lens 508 may have a convex shape, and a paraxial region of an image-side surface of the eighth lens 508 may have a concave shape.

The ninth lens 509 may have positive refractive power, paraxial regions of an object-side surface and an image-side surface of the ninth lens 509 may each have a convex shape.

In addition, at least one of an object-side surface and an image-side surface of at least one lens, among the seventh to ninth lenses 507 to 509, may have at least one inflection point.

A surface of each of the first to ninth lenses 501 to 509 may have an aspherical coefficient, as indicated in Table 10. For example, the object-side surface of the first lens 501 may be a spherical surface, and the image-side surface of the first lens 501 and the object-side surfaces and the image-side surfaces of the second to ninth lenses 502 to 509 may all be aspherical surfaces.

TABLE 10

| | S1 | S2 | S3 | S4 | S5 | S6 |
|---|---|---|---|---|---|---|
| Conic constant (K) | 0.000E+00 | 0.000E+00 | 6.691E−03 | 1.280E+01 | 2.062E+00 | −2.013E−01 |
| Fourth-order | 0.000E+00 | −1.211E−03 | −2.454E−02 | −5.509E−02 | −4.705E−02 | −4.820E−02 |
| coefficient (A) | | | | | | |
| Sixth-order | 0.000E+00 | 6.482E−05 | 2.954E−01 | 9.054E−01 | 1.903E−02 | −6.607E−02 |
| coefficient (B) | | | | | | |
| Eighth-order | 0.000E+00 | 3.888E−05 | −1.971E+00 | −8.457E+00 | 5.309E−01 | 1.741E+00 |
| coefficient (C) | | | | | | |
| Tenth-order | 0.000E+00 | 7.231E−06 | 8.125E+00 | 5.284E+01 | −3.089E+00 | −1.119E+01 |
| coefficient (D) | | | | | | |
| Twelfth-order | 0.000E+00 | 6.610E−07 | −2.231E+01 | −2.273E+02 | 1.041E+01 | 4.678E+01 |
| coefficient (E) | | | | | | |
| Fourteenth-order | 0.000E+00 | 3.023E−07 | 4.256E+01 | 6.938E+02 | −2.425E+01 | −1.436E+02 |
| coefficient (F) | | | | | | |
| Sixteenth-order | 0.000E+00 | −1.402E−07 | −5.768E+01 | −1.531E+03 | 4.101E+01 | 3.396E+02 |
| coefficient (G) | | | | | | |
| Eighteenth-order | 0.000E+00 | −1.352E−07 | 5.619E+01 | 2.462E+03 | −5.091E+01 | −6.204E+02 |
| coefficient (H) | | | | | | |
| Twentieth-order | 0.000E+00 | −4.142E−08 | −3.937E+01 | −2.882E+03 | 4.618E+01 | 8.566E+02 |
| coefficient (J) | | | | | | |
| Twenty second-order | 0.000E+00 | 0.000E+00 | 1.964E+01 | 2.425E+03 | −3.012E+01 | −8.643E+02 |
| coefficient (L) | | | | | | |
| Twenty fourth-order | 0.000E+00 | 0.000E+00 | −6.794E+00 | −1.427E+03 | 1.372E+01 | 6.111E+02 |
| coefficient (M) | | | | | | |
| Twenty sixth-order | 0.000E+00 | 0.000E+00 | 1.547E+00 | 5.572E+02 | −4.130E+00 | −2.849E+02 |
| coefficient (N) | | | | | | |
| Twenty eighth-order | 0.000E+00 | 0.000E+00 | −2.085E−01 | −1.295E+02 | 7.376E−01 | 7.834E+01 |
| coefficient (O) | | | | | | |
| Thirtieth-order | 0.000E+00 | 0.000E+00 | 1.257E−02 | 1.357E+01 | −5.911E−02 | −9.597E+00 |
| coefficient (P) | | | | | | |

| | S7 | S8 | S9 | S10 | S11 | S12 |
|---|---|---|---|---|---|---|
| Conic constant (K) | −1.000E+00 | 1.910E+01 | 9.962E+00 | −4.111E+00 | −5.521E+00 | 1.659E+01 |
| Fourth-order | −3.873E−02 | −3.193E−02 | −6.737E−02 | −5.414E−02 | −4.717E−02 | 1.920E−03 |
| coefficient (A) | | | | | | |
| Sixth-order | −8.072E−02 | −7.856E−02 | 4.337E−02 | −1.199E−02 | 4.622E−01 | 1.449E−03 |
| coefficient (B) | | | | | | |
| Eighth-order | 7.894E−01 | 8.712E−01 | −1.762E−01 | 1.887E−01 | −2.046E+00 | −1.360E−02 |
| coefficient (C) | | | | | | |
| Tenth-order | −4.012E+00 | −4.795E+00 | 6.415E−01 | −5.253E−01 | 5.433E+00 | −4.830E−02 |
| coefficient (D) | | | | | | |
| Twelfth-order | 1.337E+01 | 1.567E+01 | −2.297E+00 | 8.437E−01 | −9.505E+00 | 2.077E−01 |
| coefficient (E) | | | | | | |
| Fourteenth-order | −2.976E+01 | −3.352E+01 | 6.226E+00 | −9.254E−01 | 1.155E+01 | −3.344E−01 |
| coefficient (F) | | | | | | |
| Sixteenth-order | 4.430E+01 | 4.938E+01 | −1.197E+01 | 7.369E−01 | −1.005E+01 | 3.178E−01 |
| coefficient (G) | | | | | | |
| Eighteenth-order | −4.411E+01 | −5.137E+01 | 1.642E+01 | −4.354E−01 | 6.347E+00 | −2.023E−01 |
| coefficient (H) | | | | | | |
| Twentieth-order | 2.894E+01 | 3.792E+01 | −1.621E+01 | 1.908E−01 | −2.915E+00 | 9.042E−02 |
| coefficient (J) | | | | | | |
| Twenty second-order | −1.197E+01 | −1.956E+01 | 1.145E+01 | −6.103E−02 | 9.629E−01 | −2.868E−02 |
| coefficient (L) | | | | | | |
| Twenty fourth-order | 2.813E+00 | 6.741E+00 | −5.666E+00 | 1.379E−02 | −2.227E−01 | 6.334E−03 |
| coefficient (M) | | | | | | |
| Twenty sixth-order | −2.839E−01 | −1.401E+00 | 1.865E+00 | −2.080E−03 | 3.421E−02 | −9.266E−04 |
| coefficient (N) | | | | | | |
| Twenty eighth-order | 0.000E+00 | 1.333E−01 | −3.667E−01 | 1.873E−04 | −3.132E−03 | 8.055E−05 |
| coefficient (O) | | | | | | |
| Thirtieth-order | 0.000E+00 | 0.000E+00 | 3.261E−02 | −7.598E−06 | 1.293E−04 | −3.145E−06 |
| coefficient (P) | | | | | | |

| | S13 | S14 | S15 | S16 | S17 | S18 |
|---|---|---|---|---|---|---|
| Conic constant (K) | −2.686E+00 | 2.550E−01 | −1.000E+00 | −1.000E+00 | −1.000E+00 | −1.000E+00 |
| Fourth-order | −5.762E−02 | −7.411E−02 | −2.115E−01 | −2.924E−01 | −4.349E−01 | 3.583E−01 |
| coefficient (A) | | | | | | |
| Sixth-order | 1.075E−03 | 7.895E−02 | 3.748E−01 | 5.085E−01 | 3.074E−01 | −2.644E−01 |
| coefficient (B) | | | | | | |
| Eighth-order | −7.635E−03 | −1.502E−01 | −4.823E−01 | −5.578E−01 | −1.486E−01 | 1.110E−01 |
| coefficient (C) | | | | | | |
| Tenth-order | 1.381E−01 | 2.232E−01 | 3.974E−01 | 3.920E−01 | 5.114E−02 | −3.007E−02 |
| coefficient (D) | | | | | | |
| Twelfth-order | −3.350E−01 | −2.261E−01 | −2.216E−01 | −1.873E−01 | −1.258E−02 | 5.596E−03 |
| coefficient (E) | | | | | | |
| Fourteenth-order | 4.160E−01 | 1.570E−01 | 8.666E−02 | 6.303E−02 | 2.235E−03 | −7.417E−04 |
| coefficient (F) | | | | | | |
| Sixteenth-order | −3.232E−01 | −7.667E−02 | −2.427E−02 | −1.527E−02 | −2.890E−04 | 7.146E−05 |
| coefficient (G) | | | | | | |
| Eighteenth-order | 1.689E−01 | 2.680E−02 | 4.925E−03 | 2.688E−03 | 2.733E−05 | −5.050E−06 |
| coefficient (H) | | | | | | |
| Twentieth-order | −6.111E−02 | −6.746E−03 | −7.242E−04 | −3.441E−04 | −1.884E−06 | 2.614E−07 |
| coefficient (J) | | | | | | |
| Twenty second-order | 1.539E−02 | 1.214E−03 | 7.631E−05 | 3.165E−05 | 9.344E−08 | −9.792E−09 |
| coefficient (L) | | | | | | |
| Twenty fourth-order | −2.653E−03 | −1.525E−04 | −5.607E−06 | −2.037E−06 | −3.243E−09 | 2.580E−10 |
| coefficient (M) | | | | | | |
| Twenty sixth-order | 2.988E−04 | 1.271E−05 | 2.722E−07 | 8.697E−08 | 7.465E−11 | −4.532E−12 |
| coefficient (N) | | | | | | |
| Twenty eighth-order | −1.983E−05 | −6.321E−07 | −7.827E−09 | −2.212E−09 | −1.023E−12 | 4.762E−14 |
| coefficient (O) | | | | | | |
| Thirtieth-order | 5.883E−07 | 1.420E−08 | 1.006E−10 | 2.534E−11 | 6.318E−15 | −2.264E−16 |
| coefficient (P) | | | | | | |

In addition, the optical imaging system configured as described above may have aberration properties as illustrated in FIG. 10.

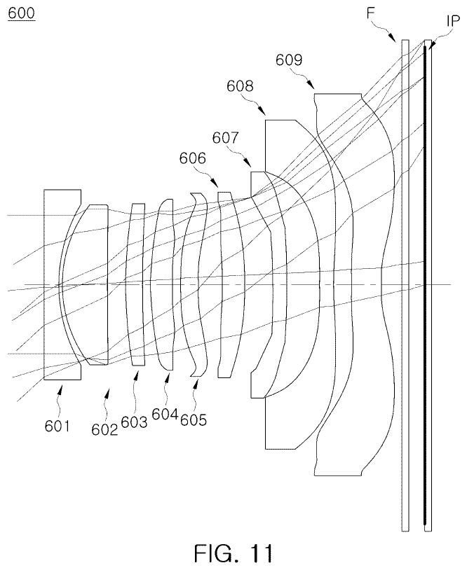

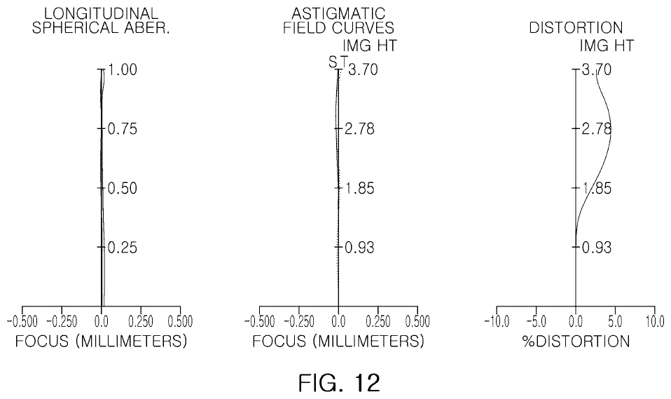

An optical imaging system 600 according to a sixth example embodiment of the present disclosure will be described with reference to FIGS. 11 and 12.

The optical imaging system 600 according to the sixth example embodiment of the present disclosure may include a first lens 601, a second lens 602, a third lens 603, a fourth lens 604, a fifth lens 605, a sixth lens 606, a seventh lens 607, an eighth lens 608, and a ninth lens 609, and may further include a filter F and an image sensor.

The optical imaging system 600 according to the sixth example embodiment of the present disclosure may form a focal point on an imaging plane IP.

Lens properties (a radius of curvature, a thickness of a lens or a distance between lenses, an index, and an Abbe number) of each lens are indicated in Table 11.

TABLE 11

| Surface | | Radius of | Thickness | | Abbe |
|---|---|---|---|---|---|
| No. | | Curvature | or Distance | Index | number |
| S1 | First lens | Infinity | 0.200 | 1.646 | 23.5 |
| S2 | | 2.500 | 0.050 | | |
| S3 | Second | 1.611 | 0.676 | 1.547 | 56.1 |
| | lens | | | | |
| S4 | | 13.291 | 0.273 | | |
| S5 | Third | 4.516 | 0.259 | 1.669 | 20.4 |
| | lens | | | | |
| S6 | | 9.029 | 0.100 | | |
| S7 | Fourth | 3.456 | 0.308 | 1.547 | 56.1 |
| | lens | | | | |
| S8 | | 3.650 | 0.124 | | |
| S9 | Fifth lens | 1.931 | 0.260 | 1.547 | 56.1 |
| S10 | | 3.738 | 0.354 | | |
| S11 | Sixth | −21.907 | 0.330 | 1.537 | 55.7 |
| | lens | | | | |
| S12 | | −4.867 | 0.400 | | |
| S13 | Seventh | 78.995 | 0.201 | 1.669 | 20.4 |
| | lens | | | | |
| S14 | | −76.201 | 0.494 | | |
| S15 | Eighth | −3.988 | 0.200 | 1.646 | 23.5 |
| | lens | | | | |
| S16 | | 14.028 | 0.255 | | |
| S17 | Ninth | 4.159 | 0.441 | 1.537 | 55.7 |
| | lens | | | | |
| S18 | | 1.762 | 0.310 | | |
| S19 | Filter | Infinity | 0.110 | 1.519 | 64.2 |
| 21 | | Infinity | 0.217 | | |
| Image | Imaging | Infinity | | | |
| | plane | | | | |

In the sixth example embodiment of the present disclosure, the first lens 601 may have negative refractive power, a paraxial region of an object-side surface of the first lens 601 may be a plane, and a paraxial region of an image-side surface of the first lens 601 may have a concave shape.

The second lens 602 may have positive refractive power, a paraxial region of an object-side surface of the second lens 602 may have a convex shape, and a paraxial region of an image-side surface of the second lens 602 may have a concave shape.

The third lens 603 may have positive refractive power, a paraxial region of an object-side surface of the third lens 603 may have a convex shape, and a paraxial region of an image-side surface of the third lens 603 may have a concave shape.

The fourth lens 604 may have positive refractive power, a paraxial region of an object-side surface of the fourth lens 604 may have a convex shape, and a paraxial region of an image-side surface of the fourth lens 604 may have a concave shape.

The fifth lens 605 may have positive refractive power, a paraxial region of an object-side surface of the fifth lens 605 may have a convex shape, and a paraxial region of an image-side surface of the fifth lens 605 may have a concave shape.

The sixth lens 606 may have positive refractive power, a paraxial region of an object-side surface of the sixth lens 606 may have a concave shape, and a paraxial region of an image-side surface of the sixth lens 606 may have a convex shape.

The seventh lens 607 may have positive refractive power, paraxial regions of an object-side surface and an image-side surface of the seventh lens 607 may each have a convex shape.

The eighth lens 608 may have negative refractive power, paraxial regions of an object-side surface and an image-side surface of the eighth lens 608 may each have a concave shape.

The ninth lens 609 may have negative refractive power, a paraxial region of an object-side surface of the ninth lens 609 may have a convex shape, and a paraxial region of an image-side surface of the ninth lens 609 may have a concave shape.

In addition, at least one of an object-side surface and an image-side surface of at least one lens, among the seventh to ninth lenses 607 to 609, may have at least one inflection point.

A surface of each of the first to ninth lenses 601 to 609 may have an aspherical coefficient, as indicated in Table 12. For example, the object-side surface of the first lens 601 may be a spherical surface, and the image-side surface of the first lens 601 and the object-side surfaces and the image-side surfaces of the second to ninth lenses 602 to 609 may all be aspherical surfaces.

TABLE 12

| | S1 | S2 | S3 | S4 | S5 | S6 |
|---|---|---|---|---|---|---|
| Conic constant (K) | 0.000E+00 | 0.000E+00 | −1.704E+00 | −1.065E+01 | −3.038E+01 | −4.804E+00 |
| Fourth-order | 0.000E+00 | −9.869E−03 | 1.606E−02 | −6.530E−03 | −1.175E−02 | −5.717E−02 |
| coefficient (A) | | | | | | |
| Sixth-order | 0.000E+00 | 1.003E−02 | −2.268E−02 | −2.911E−02 | −2.839E−02 | −4.286E−02 |
| coefficient (B) | | | | | | |
| Eighth-order | 0.000E+00 | 3.612E−03 | 1.318E−01 | 8.594E−02 | −1.319E−01 | −1.016E−01 |
| coefficient (C) | | | | | | |
| Tenth-order | 0.000E+00 | 2.838E−05 | −3.478E−01 | −2.812E−01 | 5.659E−01 | 7.892E−01 |
| coefficient (D) | | | | | | |
| Twelfth-order | 0.000E+00 | −4.478E−04 | 5.575E−01 | 5.404E−01 | −1.144E+00 | −1.861E+00 |
| coefficient (E) | | | | | | |
| Fourteenth-order | 0.000E+00 | 1.577E−04 | −5.537E−01 | −6.296E−01 | 1.318E+00 | 2.353E+00 |
| coefficient (F) | | | | | | |
| Sixteenth-order | 0.000E+00 | 8.365E−05 | 3.290E−01 | 4.354E−01 | −8.493E−01 | −1.678E+00 |
| coefficient (G) | | | | | | |
| Eighteenth-order | 0.000E+00 | 8.703E−13 | −1.066E−01 | −1.628E−01 | 2.917E−01 | 6.507E−01 |
| coefficient (H) | | | | | | |
| Twentieth-order | 0.000E+00 | 3.943E−14 | 1.439E−02 | 2.516E−02 | −4.265E−02 | −1.079E−01 |
| coefficient (J) | | | | | | |

| | S7 | S8 | S9 | S10 | S11 | S12 |
|---|---|---|---|---|---|---|
| Conic constant (K) | −1.186E+01 | −5.317E+01 | −3.786E−01 | 3.273E+00 | 0.000E+00 | 0.000E+00 |
| Fourth-order | 1.225E−02 | −2.254E−02 | −1.661E−01 | −3.665E−02 | −3.799E−03 | 3.991E−04 |
| coefficient (A) | | | | | | |
| Sixth-order | −5.892E−02 | −9.113E−02 | 2.154E−01 | 8.308E−02 | −2.750E−04 | −1.281E−03 |
| coefficient (B) | | | | | | |
| Eighth-order | −1.433E−01 | 2.969E−02 | −6.675E−01 | −3.960E−01 | 2.985E−04 | −1.083E−03 |
| coefficient (C) | | | | | | |
| Tenth-order | 8.053E−01 | 1.792E−01 | 1.588E+00 | 1.002E+00 | −4.588E−05 | −3.411E−04 |
| coefficient (D) | | | | | | |
| Twelfth-order | −1.742E+00 | −4.820E−01 | −2.485E+00 | −1.512E+00 | −1.694E−04 | 3.592E−05 |
| coefficient (E) | | | | | | |
| Fourteenth-order | 2.024E+00 | 5.211E−01 | 2.454E+00 | 1.403E+00 | −2.112E−04 | 1.524E−04 |
| coefficient (F) | | | | | | |
| Sixteenth-order | −1.323E+00 | −2.356E−01 | −1.450E+00 | −7.783E−01 | −9.990E−14 | 1.032E−13 |
| coefficient (G) | | | | | | |
| Eighteenth-order | 4.706E−01 | 1.962E−02 | 4.668E−01 | 2.352E−01 | −5.521E−15 | 1.002E−14 |
| coefficient (H) | | | | | | |
| Twentieth-order | −7.187E−02 | 1.161E−02 | −6.313E−02 | −2.984E−02 | −2.633E−16 | 5.431E−16 |
| coefficient (J) | | | | | | |

| | S13 | S14 | S15 | S16 | S17 | S18 |
|---|---|---|---|---|---|---|
| Conic constant (K) | 0.000E+00 | 0.000E+00 | 0.000E+00 | 0.000E+00 | −9.536E+00 | −9.090E+00 |
| Fourth-order | 7.497E−03 | 6.817E−02 | 9.380E−02 | 4.192E−02 | −2.194E−01 | −9.725E−02 |
| coefficient (A) | | | | | | |
| Sixth-order | −2.347E−01 | −2.292E−01 | −1.505E−01 | −3.808E−02 | 2.416E−01 | 7.490E−02 |
| coefficient (B) | | | | | | |
| Eighth-order | 4.836E−01 | 3.749E−01 | 7.762E−02 | −2.339E−02 | −1.606E−01 | −3.665E−02 |
| coefficient (C) | | | | | | |
| Tenth-order | −8.938E−01 | −5.811E−01 | −2.583E−02 | 3.591E−02 | 6.033E−02 | 1.097E−02 |
| coefficient (D) | | | | | | |
| Twelfth-order | 1.064E+00 | 6.248E−01 | 6.687E−03 | −1.775E−02 | −1.337E−02 | −2.052E−03 |
| coefficient (E) | | | | | | |
| Fourteenth-order | −7.646E−01 | −4.156E−01 | 4.433E−03 | 4.626E−03 | 1.747E−03 | 2.342E−04 |
| coefficient (F) | | | | | | |
| 1 Sixteenth-order | 3.179E−01 | 1.643E−01 | −5.426E−03 | −6.779E−04 | −1.245E−04 | −1.493E−05 |
| coefficient (G) | | | | | | |
| Eighteenth-order | −6.852E−02 | −3.556E−02 | 1.777E−03 | 5.271E−05 | 3.719E−06 | 4.091E−07 |
| coefficient (H) | | | | | | |
| Twentieth-order | 5.514E−03 | 3.266E−03 | −1.887E−04 | −1.689E−06 | 0.000E+00 | 0.000E+00 |
| coefficient (J) | | | | | | |

In addition, the optical imaging system configured as described above may have aberration properties as illustrated in FIG. 12.

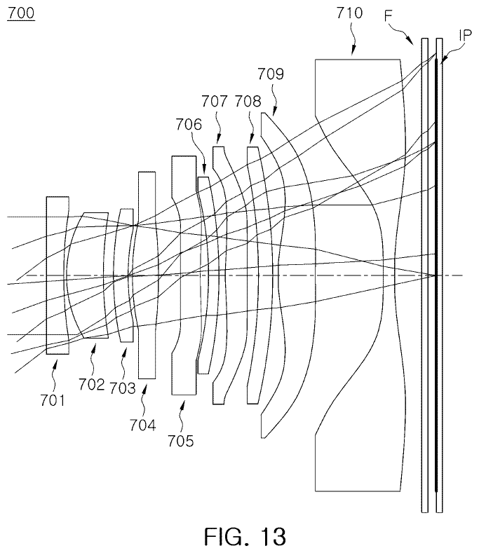

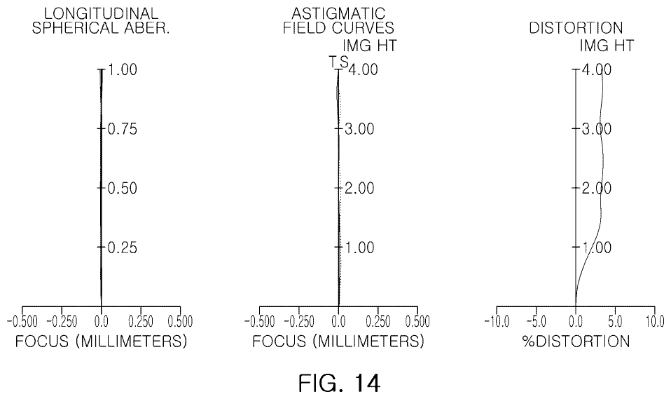

An optical imaging system 700 according to a seventh example embodiment of the present disclosure will be described with reference to FIGS. 13 and 14.

The optical imaging system 700 according to the seventh example embodiment of the present disclosure may include a first lens 701, a second lens 702, a third lens 703, a fourth lens 704, a fifth lens 705, a sixth lens 706, a seventh lens 707, an eighth lens 708, a ninth lens 709, and a tenth lens 710, and may further include a filter F and an image sensor.

The optical imaging system 700 according to the seventh example embodiment of the present disclosure may form a focal point on an imaging plane IP.

Lens properties (a radius of curvature, a thickness of a lens or a distance between lenses, an index, and an Abbe number) of each lens are indicated in Table 13.

TABLE 13

| Surface | | Radius of | Thickness | | Abbe |
|---|---|---|---|---|---|
| No. | | Curvature | or Distance | Index | number |
| S1 | First lens | Infinity | 0.300 | 1.547 | 56.1 |
| S2 | | 8.000 | 0.050 | | |
| S3 | Second | 2.001 | 0.697 | 1.547 | 56.1 |
| | lens | | | | |
| S4 | | 15.547 | 0.113 | | |
| S5 | Third lens | 5.953 | 0.258 | 1.689 | 18.2 |
| S6 | | 3.410 | 0.135 | | |
| S7 | Fourth | 6.098 | 0.380 | 1.537 | 55.7 |
| | lens | | | | |
| S8 | | 45.887 | 0.427 | | |
| S9 | Fifth lens | 22.584 | 0.334 | 1.547 | 56.1 |
| S10 | | 12.693 | 0.124 | | |
| S11 | Sixth lens | −6.433 | 0.200 | 1.646 | 23.5 |
| S12 | | −10.502 | 0.111 | | |
| S13 | Seventh | 7.334 | 0.403 | 1.571 | 37.4 |
| | lens | | | | |
| S14 | | 20.766 | 0.229 | | |
| S15 | Eighth | −7.893 | 0.200 | 1.646 | 23.5 |
| | lens | | | | |
| S16 | | −12.548 | 0.100 | | |
| S17 | Ninth lens | 4.167 | 0.648 | 1.547 | 56.1 |
| S18 | | −20.366 | 1.164 | | |
| S19 | Tenth | −179.464 | 0.208 | 1.537 | 55.7 |
| | lens | | | | |
| 21 | | 2.515 | 0.486 | | |
| 22 | Filter | Infinity | 0.110 | 1.519 | 64.2 |
| 23 | | Infinity | 0.147 | | |
| Image | Imaging | Infinity | | | |
| | plane | | | | |

In the seventh example embodiment of the present disclosure, the first lens 701 may have negative refractive power, a paraxial region of an object-side surface of the first lens 701 may be a plane, and a paraxial region of an image-side surface of the first lens 701 may have a concave shape.

The second lens 702 may have positive refractive power, a paraxial region of an object-side surface of the second lens 702 may have a convex shape, and a paraxial region of an image-side surface of the second lens 702 may have a concave shape.

The third lens 703 may have negative refractive power, a paraxial region of an object-side surface of the third lens 703 may have a convex shape, and a paraxial region of an image-side surface of the third lens 703 may have a concave shape.

The fourth lens 704 may have positive refractive power, a paraxial region of an object-side surface of the fourth lens 704 may have a convex shape, and a paraxial region of an image-side surface of the fourth lens 704 may have a concave shape.

The fifth lens 705 may have negative refractive power, a paraxial region of an object-side surface of the fifth lens 705 may have a convex shape, and a paraxial region of an image-side surface of the fifth lens 705 may have a concave shape.

The sixth lens 706 may have negative refractive power, a paraxial region of an object-side surface of the sixth lens 706 may have a concave shape, and a paraxial region of an image-side surface of the sixth lens 706 may have a convex shape.

The seventh lens 707 may have positive refractive power, a paraxial region of an object-side surface of the seventh lens 707 may have a convex shape, and a paraxial region of an image-side surface of the seventh lens 707 may have a concave shape.

The eighth lens 708 may have negative refractive power, a paraxial region of an object-side surface of the eighth lens 708 may have a concave shape, and a paraxial region of an image-side surface of the eighth lens 708 may have a convex shape.

The ninth lens 709 may have positive refractive power, paraxial regions of an object-side surface and an image-side surface of the ninth lens 709 may each have a convex shape.

The tenth lens 710 may have negative refractive power, paraxial regions of an object-side surface and an image-side surface of the eighth lens tenth may each have a concave shape.

In addition, at least one of an object-side surface and an image-side surface of at least one lens, among the seventh to tenth lenses 707 to 710, may have at least one inflection point.

A surface of each of the first to tenth lenses 701 to 710 may have an aspherical coefficient, as indicated in Table 14. For example, the object-side surface of the first lens 701 may be a spherical surface, and the image-side surface of the first lens 701 and the object-side surfaces and the image-side surfaces of the second to tenth lenses 702 to 710 may all be aspherical surfaces.

TABLE 14

| | S1 | S2 | S3 | S4 | S5 | S6 | S7 |
|---|---|---|---|---|---|---|---|
| Conic constant (K) | 0.000E+00 | 0.000E+00 | 1.333E−02 | 4.859E+00 | 1.028E+00 | 2.464E−01 | −1.000E+00 |
| Fourth-order | 0.000E+00 | −2.428E−04 | 6.332E−03 | −8.863E−03 | −4.295E−02 | −3.608E−02 | −3.319E−02 |
| coefficient (A) | | | | | | | |
| Sixth-order | 0.000E+00 | 3.800E−04 | −9.300E−02 | −2.646E−02 | 2.026E−01 | −4.043E−02 | −2.587E−02 |
| coefficient (B) | | | | | | | |
| Eighth-order | 0.000E+00 | 1.712E−04 | 7.918E−01 | 7.109E−01 | −1.851E+00 | 1.928E+00 | 4.473E−01 |
| coefficient (C) | | | | | | | |
| Tenth-order | 0.000E+00 | 3.814E−05 | −4.094E+00 | −5.714E+00 | 1.359E+01 | −1.741E+01 | −2.865E+00 |
| coefficient (D) | | | | | | | |
| Twelfth-order | 0.000E+00 | −1.992E−06 | 1.379E+01 | 2.766E+01 | −6.566E+01 | 9.277E+01 | 1.167E+01 |
| coefficient (E) | | | | | | | |
| Fourteenth-order | 0.000E+00 | −3.714E−06 | −3.173E+01 | −8.985E+01 | 2.147E+02 | −3.258E+02 | −3.292E+01 |
| coefficient (F) | | | | | | | |
| Sixteenth-order | 0.000E+00 | −1.090E−06 | 5.138E+01 | 2.043E+02 | −4.905E+02 | 7.887E+02 | 6.671E+01 |
| coefficient (G) | | | | | | | |
| Eighteenth-order | 0.000E+00 | −3.901E−09 | −5.951E+01 | −3.318E+02 | 7.988E+02 | −1.342E+03 | −9.887E+01 |
| coefficient (H) | | | | | | | |
| Twentieth-order | 0.000E+00 | 2.970E−09 | 4.947E+01 | 3.868E+02 | −9.327E+02 | 1.605E+03 | 1.076E+02 |
| coefficient (J) | | | | | | | |
| Twenty second-order | 0.000E+00 | 0.000E+00 | −2.925E+01 | −3.210E+02 | 7.754E+02 | −1.326E+03 | −8.506E+01 |
| coefficient (L) | | | | | | | |
| Twenty fourth-order | 0.000E+00 | 0.000E+00 | 1.199E+01 | 1.850E+02 | −4.481E+02 | 7.222E+02 | 4.742E+01 |
| coefficient (M) | | | | | | | |
| Twenty sixth-order | 0.000E+00 | 0.000E+00 | −3.233E+00 | −7.031E+01 | 1.711E+02 | −2.338E+02 | −1.763E+01 |
| coefficient (N) | | | | | | | |
| Twenty eighth-order | 0.000E+00 | 0.000E+00 | 5.153E−01 | 1.584E+01 | −3.882E+01 | 3.415E+01 | 3.907E+00 |
| coefficient (O) | | | | | | | |
| Thirtieth-order | 0.000E+00 | 0.000E+00 | −3.670E−02 | −1.602E+00 | 3.963E+00 | 0.000E+00 | −3.898E−01 |
| coefficient (P) | | | | | | | |

| | S8 | S9 | S10 | S11 | S12 | S13 | S14 |
|---|---|---|---|---|---|---|---|
| Conic constant (K) | 7.841E+01 | 1.239E+01 | −7.070E−01 | −3.086E+00 | 8.462E+00 | −6.844E+00 | −1.503E+00 |
| Fourth-order | −1.722E−02 | −5.592E−02 | −9.429E−02 | −4.953E−02 | 1.178E−02 | −4.365E−03 | −5.516E−02 |
| coefficient (A) | | | | | | | |
| Sixth-order | −9.880E−02 | 7.386E−02 | 3.123E−01 | 2.665E−01 | −9.077E−02 | −1.422E−01 | 3.952E−02 |
| coefficient (B) | | | | | | | |
| Eighth-order | 9.683E−01 | −2.525E−01 | −9.324E−01 | −6.569E−01 | 3.244E−01 | 3.391E−01 | −8.899E−02 |
| coefficient (C) | | | | | | | |
| Tenth-order | −5.828E+00 | 4.468E−01 | 1.893E+00 | 1.029E+00 | −7.154E−01 | −4.764E−01 | 1.655E−01 |
| coefficient (D) | | | | | | | |
| Twelfth-order | 2.276E+01 | −3.488E−01 | −2.792E+00 | −1.121E+00 | 1.034E+00 | 4.393E−01 | −2.008E−01 |
| coefficient (E) | | | | | | | |
| Fourteenth-order | −6.098E+01 | −2.307E−01 | 3.063E+00 | 8.876E−01 | −1.022E+00 | −2.756E−01 | 1.629E−01 |
| coefficient (F) | | | | | | | |
| Sixteenth-order | 1.159E+02 | 9.715E−01 | −2.512E+00 | −5.233E−01 | 7.086E−01 | 1.174E−01 | −9.154E−02 |
| coefficient (G) | | | | | | | |
| Eighteenth-order | −1.589E+02 | −1.308E+00 | 1.535E+00 | 2.326E−01 | −3.494E−01 | −3.234E−02 | 3.639E−02 |
| coefficient (H) | | | | | | | |
| Twentieth-order | 1.583E+02 | 1.069E+00 | −6.926E−01 | −7.848E−02 | 1.224E−01 | 4.661E−03 | −1.030E−02 |
| coefficient (J) | | | | | | | |
| Twenty second-order | −1.136E+02 | −5.825E−01 | 2.268E−01 | 2.023E−02 | −2.996E−02 | 1.713E−04 | 2.060E−03 |
| coefficient (L) | | | | | | | |
| Twenty fourth-order | 5.727E+01 | 2.137E−01 | −5.231E−02 | −3.984E−03 | 4.941E−03 | −2.249E−04 | −2.838E−04 |
| coefficient (M) | | | | | | | |
| Twenty sixth-order | −1.926E+01 | −5.079E−02 | 8.043E−03 | 5.809E−04 | −5.098E−04 | 4.551E−05 | 2.551E−05 |
| coefficient (N) | | | | | | | |
| Twenty eighth-order | 3.882E+00 | 7.074E−03 | −7.390E−04 | −5.625E−05 | 2.823E−05 | −4.332E−06 | −1.338E−06 |
| coefficient (O) | | | | | | | |
| Thirtieth-order | −3.544E−01 | −4.383E−04 | 3.066E−05 | 2.664E−06 | −5.535E−07 | 1.686E−07 | 3.071E−08 |
| coefficient (P) | | | | | | | |

| | S15 | S16 | S17 | S18 | S19 | S20 |
|---|---|---|---|---|---|---|
| Conic constant (K) | −3.597E+00 | 4.357E+00 | 3.356E−01 | 4.495E−01 | 3.716E+00 | −1.538E+01 |
| Fourth-order | −2.496E−05 | 8.542E−03 | −2.974E−02 | 1.172E−02 | −6.246E−02 | 4.965E−02 |
| coefficient (A) | | | | | | |
| Sixth-order | −4.963E−07 | −5.355E−02 | −2.513E−02 | −9.939E−03 | −8.628E−02 | −9.974E−02 |
| coefficient (B) | | | | | | |
| Eighth-order | −3.636E−09 | 9.606E−02 | 4.384E−02 | 3.678E−03 | 1.524E−01 | 8.018E−02 |
| coefficient (C) | | | | | | |
| Tenth-order | 1.945E−10 | −9.758E−02 | −4.361E−02 | −7.109E−03 | −1.537E−01 | −4.297E−02 |
| coefficient (D) | | | | | | |
| Twelfth-order | 5.114E−11 | 6.532E−02 | 2.952E−02 | 7.959E−03 | 1.141E−01 | 1.680E−02 |
| coefficient (E) | | | | | | |
| Fourteenth-order | 6.255E−12 | −3.071E−02 | −1.429E−02 | −4.849E−03 | −6.316E−02 | −4.873E−03 |
| coefficient (F) | | | | | | |
| Sixteenth-order | 5.377E−13 | 1.045E−02 | 5.005E−03 | 1.852E−03 | 2.576E−02 | 1.049E−03 |
| coefficient (G) | | | | | | |
| Eighteenth-order | 3.433E−14 | −2.604E−03 | −1.269E−03 | −4.743E−04 | −7.688E−03 | −1.671E−04 |
| coefficient (H) | | | | | | |
| Twentieth-order | 1.509E−16 | 4.746E−04 | 2.317E−04 | 8.381E−05 | 1.665E−03 | 1.956E−05 |
| coefficient (J) | | | | | | |
| Twenty second-order | 0.000E+00 | −6.245E−05 | −3.010E−05 | −1.026E−05 | −2.580E−04 | −1.657E−06 |
| coefficient (L) | | | | | | |
| Twenty fourth-order | 0.000E+00 | 5.765E−06 | 2.708E−06 | 8.526E−07 | 2.783E−05 | 9.870E−08 |
| coefficient (M) | | | | | | |
| Twenty sixth-order | 0.000E+00 | −3.537E−07 | −1.602E−07 | −4.581E−08 | −1.982E−06 | −3.918E−09 |
| coefficient (N) | | | | | | |
| Twenty eighth-order | 0.000E+00 | 1.292E−08 | 5.604E−09 | 1.426E−09 | 8.381E−08 | 9.300E−11 |
| coefficient (O) | | | | | | |
| Thirtieth-order | 0.000E+00 | −2.125E−10 | −8.772E−11 | −1.934E−11 | −1.592E−09 | −9.979E−13 |
| coefficient (P) | | | | | | |

In addition, the optical imaging system configured as described above may have aberration properties as illustrated in FIG. 14.

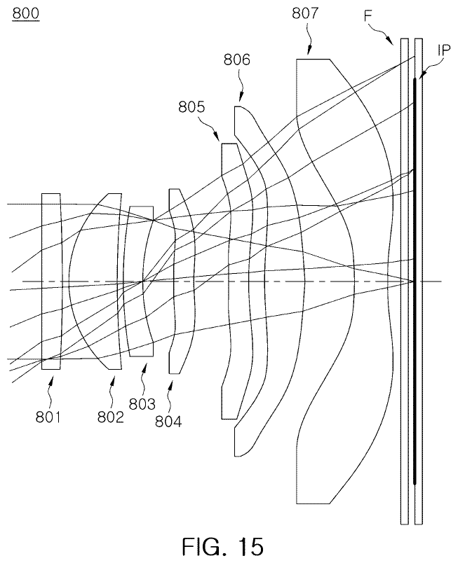

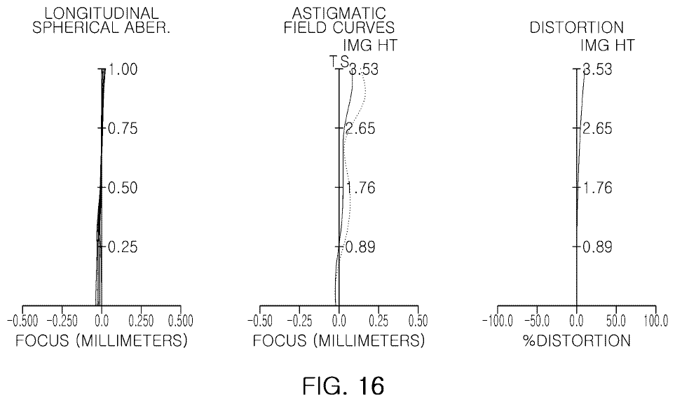

An optical imaging system 800 according to an eighth example embodiment of the present disclosure will be described with reference to FIGS. 15 and 16.

The optical imaging system 800 according to the eighth example embodiment of the present disclosure may include a first lens 801, a second lens 802, a third lens 803, a fourth lens 804, a fifth lens 805, a sixth lens 806, and a seventh lens 807, and may further include a filter F and an image sensor.

The optical imaging system 800 according to the eighth example embodiment of the present disclosure may form a focal point on an imaging plane IP.

Lens properties (a radius of curvature, a thickness of a lens or a distance between lenses, an index, and an Abbe number) of each lens are indicated in Table 15.

TABLE 15

| Surface | | Radius of | Thickness | | Abbe |
|---|---|---|---|---|---|
| No. | | Curvature | or Distance | Index | number |
| S1 | First | Infinity | 0.300 | 1.546 | 56.1 |
| | lens | | | | |
| S2 | | −20.000 | 0.100 | | |
| S3 | Second | 1.717 | 0.727 | 1.546 | 56.1 |
| | lens | | | | |
| S4 | | 4.376 | 0.110 | | |
| S5 | Third | 6.472 | 0.286 | 1.678 | 19.2 |
| | lens | | | | |
| S6 | | 3.256 | 0.487 | | |
| S7 | Fourth | 6.071 | 0.278 | 1.620 | 25.8 |
| | lens | | | | |
| S8 | | 6.659 | 0.545 | | |
| S9 | Fifth | 2.785 | 0.305 | 1.678 | 19.2 |
| | lens | | | | |
| S10 | | 2.453 | 0.250 | | |
| S11 | Sixth | 12.651 | 0.615 | 1.546 | 56.1 |
| | lens | | | | |
| S12 | | −2.695 | 0.760 | | |
| S13 | Seventh | −2.384 | 0.500 | 1.546 | 56.1 |
| | lens | | | | |
| S14 | | 3.672 | 0.200 | | |
| S15 | Filter | Infinity | 0.110 | 1.518 | 64.2 |
| S16 | | Infinity | 0.109 | | |
| S17 | Imaging | Infinity | | | |
| | plane | | | | |

In the eighth example embodiment of the present disclosure, the first lens 801 may have positive refractive power, a paraxial region of an object-side surface of the first lens 801 may be a plane, and a paraxial region of an image-side surface of the first lens 801 may have a convex shape.

The second lens 802 may have positive refractive power, a paraxial region of an object-side surface of the second lens 802 may have a convex shape, and a paraxial region of an image-side surface of the second lens 802 may have a concave shape.

The third lens 803 may have negative refractive power, a paraxial region of an object-side surface of the third lens 803 may have a convex shape, and a paraxial region of an image-side surface of the third lens 803 may have a concave shape.

The fourth lens 804 may have positive refractive power, a paraxial region of an object-side surface of the fourth lens 804 may have a convex shape, and a paraxial region of an image-side surface of the fourth lens 804 may have a concave shape.

The fifth lens 805 may have negative refractive power, a paraxial region of an object-side surface of the fifth lens 805 may have a convex shape, and a paraxial region of an image-side surface of the fifth lens 805 may have a concave shape.

The sixth lens 806 may have positive refractive power, paraxial regions of an object-side surface and an image-side surface of the sixth lens 806 may each have a convex shape.

The seventh lens 807 may have negative refractive power, and paraxial regions of an object-side surface and an image-side surface of the seventh lens 807 may each have a concave shape.

In addition, at least one of an object-side surface and an image-side surface of at least one lens, among the fourth to seventh lenses 804 to 807, may have at least one inflection point.

A surface of each of the first to seventh lenses 801 to 807 may have an aspherical coefficient, as indicated in Table 16. For example, the object-side surface and the image-side surface of the first lens 801 may both be spherical surfaces, and the object-side surfaces and the image-side surfaces of the second to seventh lenses 802 to 807 may all be aspherical surfaces.

TABLE 16

| | S1 | S2 | S3 | S4 | S5 | S6 | S7 |
|---|---|---|---|---|---|---|---|
| Conic constant (K) | 0.000E+00 | 0.000E+00 | −1.044E+00 | −2.450E+01 | 2.169E+01 | 5.397E+00 | −6.538E+01 |
| Fourth-order | 0.000E+00 | 0.000E+00 | 1.391E−02 | −4.346E−02 | −1.399E−01 | −1.236E−01 | −1.350E−01 |
| coefficient (A) | | | | | | | |
| Sixth-order | 0.000E+00 | 0.000E+00 | 8.448E−02 | 1.621E−02 | 2.309E−01 | 5.724E−01 | 3.358E−01 |
| coefficient (B) | | | | | | | |
| Eighth-order | 0.000E+00 | 0.000E+00 | −3.255E−01 | 9.185E−02 | −3.793E−01 | −2.404E+00 | −1.244E+00 |
| coefficient (C) | | | | | | | |
| Tenth-order | 0.000E+00 | 0.000E+00 | 7.815E−01 | −2.792E−01 | 6.460E−01 | 7.294E+00 | 2.932E+00 |
| coefficient (D) | | | | | | | |
| Twelfth-order | 0.000E+00 | 0.000E+00 | −1.147E+00 | 4.252E−01 | −8.061E−01 | −1.412E+01 | −4.698E+00 |
| coefficient (E) | | | | | | | |
| Fourteenth-order | 0.000E+00 | 0.000E+00 | 1.040E+00 | −3.881E−01 | 6.414E−01 | 1.725E+01 | 5.006E+00 |
| coefficient (F) | | | | | | | |
| Sixteenth-order | 0.000E+00 | 0.000E+00 | −5.678E−01 | 2.102E−01 | −3.028E−01 | −1.287E+01 | −3.375E+00 |
| coefficient (G) | | | | | | | |
| Eighteenth-order | 0.000E+00 | 0.000E+00 | 1.709E−01 | −6.179E−02 | 7.717E−02 | 5.359E+00 | 1.293E+00 |
| coefficient (H) | | | | | | | |
| Twentieth-order | 0.000E+00 | 0.000E+00 | −2.180E−02 | 7.485E−03 | −8.340E−03 | −9.529E−01 | −2.110E−01 |
| coefficient (J) | | | | | | | |
| | S8 | S9 | S10 | S11 | S12 | S13 | S14 |
| Conic constant (K) | −9.024E+01 | −2.589E+01 | −2.170E+01 | −2.763E+01 | −1.456E+00 | −8.622E+00 | −2.231E+00 |
| Fourth-order | −1.401E−01 | −8.034E−02 | −6.760E−02 | 1.706E−02 | 8.511E−02 | −4.308E−02 | −7.700E−02 |
| coefficient (A) | | | | | | | |
| Sixth-order | 3.220E−01 | 1.612E−02 | −9.518E−03 | −2.924E−02 | −3.600E−02 | −1.385E−02 | 2.265E−02 |
| coefficient (B) | | | | | | | |
| Eighth-order | −1.101E+00 | 7.179E−02 | 6.908E−02 | 1.408E−02 | 1.936E−03 | 1.617E−02 | −5.281E−03 |
| coefficient (C) | | | | | | | |
| Tenth-order | 2.442E+00 | −1.304E−01 | −7.862E−02 | −3.624E−03 | 7.878E−03 | −5.212E−03 | 8.926E−04 |
| coefficient (D) | | | | | | | |
| Twelfth-order | −3.555E+00 | 1.089E−01 | 4.732E−02 | −5.119E−05 | −5.143E−03 | 9.188E−04 | −1.021E−04 |
| coefficient (E) | | | | | | | |
| Fourteenth-order | 3.307E+00 | −5.394E−02 | −1.715E−02 | 1.232E−04 | 1.537E−03 | −9.970E−05 | 7.196E−06 |
| coefficient (F) | | | | | | | |
| Sixteenth-order | −1.884E+00 | 1.602E−02 | 3.765E−03 | 7.615E−06 | −2.449E−04 | 6.702E−06 | −2.616E−07 |
| coefficient (G) | | | | | | | |
| Eighteenth-order | 5.973E−01 | −2.594E−03 | −4.588E−04 | −5.545E−06 | 2.017E−05 | −2.582E−07 | 2.342E−09 |
| coefficient (H) | | | | | | | |
| Twentieth-order | −8.014E−02 | 1.740E−04 | 2.366E−05 | 4.292E−07 | −6.765E−07 | 4.382E−09 | 7.224E−11 |
| coefficient (J) | | | | | | | |

In addition, the optical imaging system configured as described above may have aberration properties as illustrated in FIG. 16.

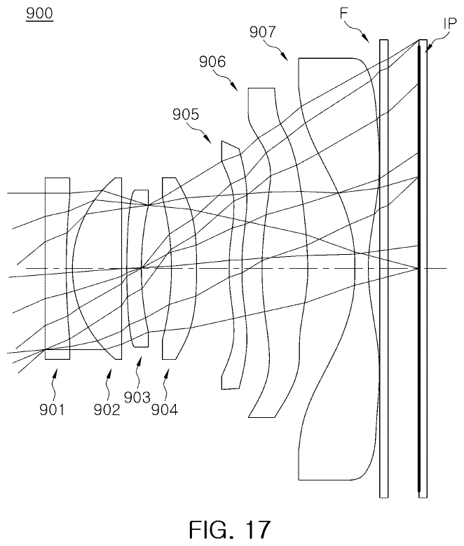

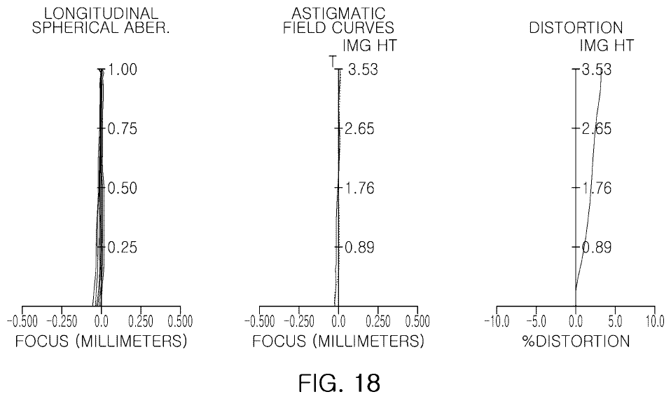

An optical imaging system 900 according to a ninth example embodiment of the present disclosure will be described with reference to FIGS. 17 and 18.

The optical imaging system 900 according to the ninth example embodiment of the present disclosure may include a first lens 901, a second lens 902, a third lens 903, a fourth lens 904, a fifth lens 905, a sixth lens 906, and a seventh lens 907, and may further include a filter F and an image sensor.

The optical imaging system 900 according to the ninth example embodiment of the present disclosure may form a focal point on an imaging plane IP.

Lens properties (a radius of curvature, a thickness of a lens or a distance between lenses, an index, and an Abbe number) of each lens are indicated in Table 17.

TABLE 17

| Surface | | Radius of | Thickness | | Abbe |
|---|---|---|---|---|---|
| No. | | Curvature | or Distance | Index | number |
| S1 | First lens | Infinity | 0.300 | 1.546 | 56.1 |
| S2 | | 8.000 | 0.100 | | |
| S3 | Second | 1.719 | 0.712 | 1.546 | 56.1 |
| | lens | | | | |
| S4 | | 16.432 | 0.101 | | |
| S5 | Third | 7.466 | 0.204 | 1.678 | 19.2 |
| | lens | | | | |
| S6 | | 4.249 | 0.451 | | |
| S7 | Fourth | 67.653 | 0.362 | 1.620 | 25.8 |
| | lens | | | | |
| S8 | | −18.401 | 0.495 | | |
| S9 | Fifth lens | 3.323 | 0.181 | 1.678 | 19.2 |
| S10 | | 2.674 | 0.298 | | |
| S11 | Sixth | 4.410 | 0.681 | 1.546 | 56.1 |
| | lens | | | | |
| S12 | | −3.316 | 0.701 | | |
| S13 | Seventh | −3.291 | 0.181 | 1.546 | 56.1 |
| | lens | | | | |
| S14 | | 2.663 | 0.182 | | |
| S15 | Eighth | Infinity | 0.110 | 1.518 | 64.2 |
| | lens | | | | |
| S16 | | Infinity | 0.451 | | |
| S17 | Filter | Infinity | 0.020 | | |
| S18 | | | | | |
| S19 | Imaging | | | | |
| | plane | | | | |

In the ninth example embodiment of the present disclosure, the first lens 901 may have negative refractive power, a paraxial region of an object-side surface of the first lens 901 may be a plane, and a paraxial region of an image-side surface of the first lens 901 may have a concave shape.

The second lens 902 may have positive refractive power, a paraxial region of an object-side surface of the second lens 902 may have a convex shape, and a paraxial region of an image-side surface of the second lens 902 may have a concave shape.

The third lens 903 may have negative refractive power, a paraxial region of an object-side surface of the third lens 903 may have a convex shape, and a paraxial region of an image-side surface of the third lens 903 may have a concave shape.

The fourth lens 904 may have positive refractive power, paraxial regions of an object-side surface and an image-side surface of the fourth lens 904 may each have a convex shape.

The fifth lens 905 may have negative refractive power, a paraxial region of an object-side surface of the fifth lens 905 may have a convex shape, and a paraxial region of an image-side surface of the fifth lens 905 may have a concave shape.

The sixth lens 906 may have positive refractive power, paraxial regions of an object-side surface and an image-side surface of the sixth lens 906 may each have a convex shape.

The seventh lens 907 may have negative refractive power, and paraxial regions of an object-side surface and an image-side surface of the seventh lens 907 may each have a concave shape.

In addition, at least one of an object-side surface and an image-side surface of at least one lens, among the fourth to seventh lenses 904 to 907, may have at least one inflection point.

A surface of each of the first to seventh lenses 901 to 907 may have an aspherical coefficient, as indicated in Table 18. For example, the object-side surface of the first lens 901 may be a spherical surface, and the image-side surface of the first lens 901 and the object-side surfaces and the image-side surfaces of the second lens 902 to seventh lens 907 may all be aspherical surfaces.

TABLE 18

| | S1 | S2 | S3 | S4 | S5 | S6 | S7 |
|---|---|---|---|---|---|---|---|
| Conic constant (K) | 0.000E+00 | 0.000E+00 | −1.044E+00 | −5.708E+01 | 2.169E+01 | 5.397E+00 | −6.538E+01 |
| Fourth-order | 0.000E+00 | −2.122E−03 | 1.896E−02 | −4.629E−02 | −1.563E−01 | −9.007E−02 | −1.276E−01 |
| coefficient (A) | | | | | | | |
| Sixth-order | 0.000E+00 | −3.825E−05 | 8.500E−02 | −1.461E−01 | 6.810E−01 | 7.240E−02 | 6.383E−01 |
| coefficient (B) | | | | | | | |
| Eighth-order | 0.000E+00 | 3.314E−04 | −7.599E−01 | 2.596E+00 | −6.676E+00 | 2.332E+00 | −6.698E+00 |
| coefficient (C) | | | | | | | |
| Tenth-order | 0.000E+00 | 2.169E−04 | 4.489E+00 | −1.794E+01 | 5.221E+01 | −3.382E+01 | 4.638E+01 |
| coefficient (D) | | | | | | | |
| Twelfth-order | 0.000E+00 | 5.597E−05 | −1.815E+01 | 7.704E+01 | −2.703E+02 | 2.807E+02 | −2.193E+02 |
| coefficient (E) | | | | | | | |
| Fourteenth-order | 0.000E+00 | −6.041E−05 | 5.187E+01 | −2.245E+02 | 9.536E+02 | −1.524E+03 | 7.285E+02 |
| coefficient (F) | | | | | | | |
| Sixteenth-order | 0.000E+00 | −1.993E−13 | −1.062E+02 | 4.598E+02 | −2.363E+03 | 5.663E+03 | −1.733E+03 |
| coefficient (G) | | | | | | | |
| Eighteenth-order | 0.000E+00 | −9.814E−15 | 1.567E+02 | −6.731E+02 | 4.187E+03 | −1.473E+04 | 2.984E+03 |
| coefficient (H) | | | | | | | |
| Twentieth-order | 0.000E+00 | −1.041E−17 | −1.665E+02 | 7.065E+02 | −5.332E+03 | 2.707E+04 | −3.720E+03 |
| coefficient (J) | | | | | | | |
| Twenty second-order | 0.000E+00 | 0.000E+00 | 1.258E+02 | −5.263E+02 | 4.844E+03 | −3.493E+04 | 3.321E+03 |
| coefficient (L) | | | | | | | |
| Twenty fourth-order | 0.000E+00 | 0.000E+00 | −6.592E+01 | 2.712E+02 | −3.063E+03 | 3.097E+04 | −2.069E+03 |
| coefficient (M) | | | | | | | |
| Twenty sixth-order | 0.000E+00 | 0.000E+00 | 2.274E+01 | −9.161E+01 | 1.281E+03 | −1.796E+04 | 8.540E+02 |
| coefficient (N) | | | | | | | |
| Twenty eighth-order | 0.000E+00 | 0.000E+00 | −4.643E+00 | 1.821E+01 | −3.186E+02 | 6.131E+03 | −2.097E+02 |
| coefficient (O) | | | | | | | |
| Thirtieth-order | 0.000E+00 | 0.000E+00 | 4.246E−01 | −1.607E+00 | 3.565E+01 | −9.344E+02 | 2.321E+01 |
| coefficient (P) | | | | | | | |

| | S8 | S9 | S10 | S11 | S12 | S13 | S14 |
|---|---|---|---|---|---|---|---|
| Conic constant (K) | −9.024E+01 | −2.589E+01 | −2.170E+01 | −2.763E+01 | −1.456E+00 | −8.622E+00 | −2.231E+00 |
| Fourth-order | −9.831E−02 | −9.388E−02 | −6.987E−02 | 1.416E−02 | 8.174E−02 | 5.454E−03 | −2.841E−02 |
| coefficient (A) | | | | | | | |
| Sixth-order | 3.255E−02 | 1.413E−01 | 4.395E−02 | −6.806E−03 | −3.349E−02 | −1.888E−01 | −1.272E−01 |
| coefficient (B) | | | | | | | |
| Eighth-order | 1.508E−01 | −5.853E−01 | −2.441E−01 | −4.888E−02 | −1.688E−02 | 2.836E−01 | 2.048E−01 |
| coefficient (C) | | | | | | | |
| Tenth-order | −2.061E+00 | 1.985E+00 | 9.409E−01 | 1.198E−01 | 8.660E−02 | −2.470E−01 | −1.780E−01 |
| coefficient (D) | | | | | | | |
| Twelfth-order | 1.093E+01 | −4.479E+00 | −2.065E+00 | −1.626E−01 | −1.517E−01 | 1.452E−01 | 1.029E−01 |
| coefficient (E) | | | | | | | |
| Fourteenth-order | −3.580E+01 | 6.923E+00 | 2.954E+00 | 1.447E−01 | 1.613E−01 | −5.980E−02 | −4.193E−02 |
| coefficient (F) | | | | | | | |
| Sixteenth-order | 7.938E+01 | −7.580E+00 | −2.928E+00 | −8.863E−02 | −1.149E−01 | 1.755E−02 | 1.236E−02 |
| coefficient (G) | | | | | | | |
| Eighteenth-order | −1.233E+02 | 5.975E+00 | 2.068E+00 | 3.812E−02 | 5.710E−02 | −3.704E−03 | −2.660E−03 |
| coefficient (H) | | | | | | | |
| Twentieth-order | 1.355E+02 | −3.400E+00 | −1.048E+00 | −1.160E−02 | −2.011E−02 | 5.624E−04 | 4.178E−04 |
| coefficient (J) | | | | | | | |
| Twenty second-order | −1.049E+02 | 1.383E+00 | 3.786E−01 | 2.487E−03 | 5.006E−03 | −6.077E−05 | −4.730E−05 |
| coefficient (L) | | | | | | | |
| Twenty fourth-order | 5.587E+01 | −3.912E−01 | −9.501E−02 | −3.672E−04 | −8.605E−04 | 4.556E−06 | 3.755E−06 |
| coefficient (M) | | | | | | | |
| Twenty sixth-order | −1.949E+01 | 7.307E−02 | 1.574E−02 | 3.552E−05 | 9.711E−05 | −2.251E−07 | −1.981E−07 |
| coefficient (N) | | | | | | | |
| Twenty eighth-order | 4.005E+00 | −8.086E−03 | −1.546E−03 | −2.026E−06 | −6.467E−06 | 6.587E−09 | 6.231E−09 |
| coefficient (O) | | | | | | | |
| Thirtieth-order | −3.674E−01 | 4.012E−04 | 6.815E−05 | 5.163E−08 | 1.924E−07 | −8.648E−11 | −8.839E−11 |
| coefficient (P) | | | | | | | |

In addition, the optical imaging system configured as described above may have aberration properties as illustrated in FIG. 18.

Table 19 indicates the values for the optical imaging systems 100 to 900 according to the first to ninth example embodiments of the present disclosure, where f is a focal length of the optical imaging system (a total focal length of the plurality of lenses for the optical imaging system), f1 is a focal length of the first lens, f2 is a focal length of the second lens, f3 is a focal length of the third lens, f4 is a focal length of the fourth lens, f5 is a focal length of the fifth lens, f6 is a focal length of the sixth lens, f7 is a focal length of the seventh lens, f8 is a focal length of the eighth lens, f9 is a focal length of the ninth lens, and f10 is a focal length of the tenth lens.

TABLE 19

| | Example 1 | Example 2 | Example 3 | Example 4 | Example 5 |
|---|---|---|---|---|---|
| f | 4.6571 | 5.8700 | 5.6928 | 3.8417 | 3.7315 |
| f1 | −6.1910 | 73.1931 | −34.7667 | −3.0955 | −9.3425 |
| f2 | 3.9921 | 4.5722 | 3.9367 | 2.8791 | 3.4412 |
| f3 | 32.9179 | −9.0045 | −8.3588 | 11.2642 | −15.8397 |
| f4 | 36.2824 | 29.8821 | 21.8422 | 85.3752 | 10.5165 |
| f5 | 6.9033 | −41.5979 | −47.5053 | 6.7581 | −27.4592 |
| f6 | 22.5051 | 1293.9493 | 55.9644 | 7.2114 | −25.1434 |
| f7 | −7.6320 | 15.7261 | 17.9107 | −19.0379 | 16.6901 |
| f8 | −6.3451 | −5.2866 | −5.4054 | −4.7715 | 17.8497 |
| f9 | | | | −7.3727 | 2.9253 |
| f10 | | | | | |
| TTL | 5.851 | 6.740 | 6.698 | 5.559 | 6.144 |
| IMG HT | 6.000 | 6.000 | 6.000 | 6.000 | 6.000 |

| | Example6 | Example 7 | Example 8 | Example 9 |
|---|---|---|---|---|
| f | 4.1124 | 5.0586 | 4.5537 | 4.1033 |
| f1 | −3.8694 | −14.6387 | 36.6347 | −14.6539 |
| f2 | 3.2864 | 4.1283 | 4.7224 | 3.4585 |
| f3 | 13.2093 | −12.0849 | −10.0314 | −14.9320 |
| f4 | 76.1600 | 13.0509 | 93.9633 | 23.3776 |
| f5 | 6.9577 | −53.6723 | −48.1672 | −22.8056 |
| f6 | 11.5827 | −26.2314 | 4.1280 | 3.5783 |
| f7 | 58.0328 | 19.6508 | −2.5728 | −2.6677 |
| f8 | −4.7854 | −33.5315 | | |
| f9 | −6.0913 | 6.3895 | | |
| f10 | | −4.6286 | | |
| TTL | 5.563 | 6.823 | 5.683 | 5.529 |
| IMG HT | 6.000 | 6.000 | 6.000 | 6.000 |

According to one or more example embodiments of the present disclosure, an optical imaging system may have high resolution while having a reduced thickness.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a plurality of lenses sequentially disposed from an object side,
wherein the plurality of lenses include a first lens, a second lens, a third lens, a fourth lens, a fifth lens, a sixth lens, and a seventh lens disposed in this order,
wherein the second lens has positive refractive power, and
wherein 0.9<|(R1+R2)/(R1−R2)|<1.1, and 0.4<TTL/(2×IMG HT)<0.65 are satisfied, where R1 is a radius of curvature of an object-side surface of the first lens, R2 is a radius of curvature of an image-side surface of the first lens, TTL is a distance on an optical axis from the object-side surface of the first lens to an imaging plane, and IMG HT is a half of a diagonal length of the imaging plane.

2. The optical imaging system of claim 1, wherein |R1|>500 mm is satisfied.

3. The optical imaging system of claim 1, wherein the object-side surface of the first lens is a plane in a paraxial region thereof.

4. The optical imaging system of claim 3, wherein the object-side surface of the first lens is a spherical surface.

5. The optical imaging system of claim 1, wherein −35<v1−v2≤0 is satisfied, where v1 is an Abbe number of the first lens, and v2 is an Abbe number of the second lens.

6. The optical imaging system of claim 1, wherein n2+n3>3.15 is satisfied, where n2 is a refractive index of the second lens, and n3 is an Abbe number of the third lens.

7. The optical imaging system of claim 1, wherein 1.0<TTL/f<1.7 is satisfied, where f is a total focal length of the plurality of lenses.

8. The optical imaging system of claim 1, wherein −2.5<f−TTL_2<−0.2 is satisfied, where f is a total focal length of the plurality of lenses, and TTL_2 is a distance on the optical axis from an object-side surface of the second lens to the imaging plane.

9. The optical imaging system of claim 1, wherein 0.05<|f/f1|<1.3 is satisfied, where f is a total focal length of the plurality of lenses, and f1 is a focal length of the first lens.

10. The optical imaging system of claim 1, wherein 0.001<D1/f<0.04 is satisfied, where D1 is a distance on the optical axis between the image-side surface of the first lens and an object-side surface of the second lens, and f is a total focal length of the plurality of lenses.

11. The optical imaging system of claim 1, wherein 0.4<f/f2+f/f3<1.7 is satisfied, where f is a total focal length of the plurality of lenses, f2 is a focal length of the second lens, and f3 is a focal length of the third lens.

12. The optical imaging system of claim 1, wherein a focal length of the second lens has a smallest absolute value, among absolute values of focal lengths of the plurality of lenses.

13. The optical imaging system of claim 1, wherein
the seventh lens is a lens disposed to be closest to the imaging plane, and
the third lens has negative refractive power, the fourth lens has positive refractive power, and the fifth lens has negative refractive power.

14. The optical imaging system of claim 1, further comprising:
an eighth lens disposed between the seventh lens and the imaging plane,
wherein each of the fourth lens and the sixth lens has positive refractive power, and
wherein the eighth lens has negative refractive power.

15. The optical imaging system of claim 1, further comprising:
an eighth lens and a ninth lens disposed between the seventh lens and the imaging plane,
wherein the fourth lens has positive refractive power.

16. The optical imaging system of claim 1, wherein when the number of lenses, among the plurality of lens, having a focal length greater than a total focal length of the plurality of lenses is Nfa and the number of the plurality of lenses is NL, Nfa>NL/2 is satisfied.
